(19) United States
(12) Patent Application Publication
(10) Pub. No.: US 2025/0205686 A1
(43) Pub. Date: Jun. 26, 2025

(54) SILICA-SUPPORTED POLYOLEFIN CATALYST SYSTEM

(71) Applicant: W.R. Grace & Co.-CONN., Columbia, MD (US)

(72) Inventors: Li Zhang, Panorama City, CA (US); Jamin L. Krinsky, Laurel, MD (US); Michael Baptiste, Laurel, MD (US); John H. Hain, Jr., Woodstock, MD (US); Rose Kent, Baltimore, MD (US); Andrew Singleton, Ellicott City, MD (US); Dave Chapman, Mount Airy, MD (US); Linping Xu, Clarksville, MD (US)

(21) Appl. No.: 18/847,317

(22) PCT Filed: Mar. 14, 2023
(86) PCT No.: PCT/US2023/064352

§ 371 Date: Sep. 16, 2024

Related U.S. Application Data
(60) Provisional application No. 63/320,579, filed on Mar. 16, 2022.

(51) Int. Cl. B01J 21/08; B01J 35/40; B01J 35/51; B01J 35/61; B01J 35/63; B01J 35/64; C08F 2/34; C08F 4/02; C08F 10/00

(52) U.S. Cl. CPC B01J 21/08; B01J 35/40; B01J 35/51; B01J 35/615; B01J 35/617; B01J 35/638; B01J 35/647; C08F 2/34; C08F 4/02; C08F 10/00; B01J 2235/30

(57) ABSTRACT

Olefin catalyst systems comprising silica supports are provided. For example, in one embodiment, the olefin polymerization catalyst system comprises a silica support, a catalyst precursor compound, and an activator. The silica support comprises a plurality of silica gel particles. Each particle comprises a rigid network of amorphous silica. The particles are spherical, single gel particles that have an average aspect ratio of about 1.2 or less, an average pore volume of from about 1.4 ml/g to about 3 ml/g, an average surface area from about 200 m2/g to about 950 m²/g, and a median particle size from about 4 μm to about 100 μm.

### CROSS REFERENCE TO RELATED APPLICATIONS

This application claims the benefit of priority to U.S. Provisional Patent Application No. 63/320,579 filed Mar. 16, 2022, which is hereby incorporated by reference, in its entirety for any and all purposes.

### BACKGROUND

Polyolefins are commonly prepared by reacting olefin monomers in the presence of catalysts composed of a support and catalytic components deposited in the pores and on the surfaces of the support. For example, typical polyolefin catalysts include Ziegler-Natta catalysts, metallocene catalysts, and chromium catalysts, all of which can contain a supporting material.

The nature of the resulting polymer is highly dependent upon the catalyst, so that variations in the characteristics of the catalyst will cause variations in, for example, the molecular weight, melt index, bulk density, particle shape, particle size, particle size distribution, and reaction temperature which may be employed to effect polymerization. Furthermore, the nature of the catalyst and its performance is highly dependent upon the properties of the material used to support the catalyst. The properties of the support are in turn dependent on its method of manufacture.

Silica supports have primarily been used because they form highly active polymerization catalysts. One known method of forming silica support particles is by milling silica gel and spray drying the milled particles. Certain properties of the silica particles, such as surface area, pore structure, and particle size can be influenced by controlling the milling and spray drying process. In this manner, the properties of silica supports can be controlled to suit a variety of different catalyst components and desired polymer types. However, there are also drawbacks to conventional spray-dried silica support particles. For example, they tend to be non-spherical, and the agglomeration of particles reduces catalyst performance. Therefore, there is a need for spherical silica supported polyolefin catalysts made from non-agglomerated support particles that have suitable surface area and pore structure for use in polyolefin catalysts.

### SUMMARY

The present disclosure is generally directed to olefin catalyst systems comprising silica supports. For example, in one embodiment, the olefin polymerization catalyst system comprises a silica support, a catalyst precursor compound, and an activator. The silica support comprises a plurality of silica gel particles. Each particle comprises a rigid network of amorphous silica. The particles are spherical, single gel particles that have an average aspect ratio of about 1.2 or less, an average pore volume of from about 1.4 ml/g to about 3 ml/g, an average surface area from about 200 m²/g to about 950 m²/g, and a median particle size from about 4 μm to about 100 μm.

In another embodiment, the olefin polymerization catalyst system comprises a silica support and a chromium compound. The silica support comprises a plurality of silica gel particles. Each particle comprises a rigid network of amorphous silica. The particles are spherical, single gel particles that have an average aspect ratio of about 1.2 or less, an average pore volume of from about 1.4 ml/g to about 3 ml/g, an average surface area from about 200 m²/g to about 950 m²/g, and a median particle size from about 4 μm to about 100 μm.

In another embodiment, the olefin polymerization catalyst system comprises a silica support, a magnesium halide, a transition metal compound, an alkylaluminum cocatalyst, and an electron donor compound. The silica support comprises a plurality of silica gel particles. Each particle comprises a rigid network of amorphous silica. The particles are spherical, single gel particles that have an average aspect ratio of about 1.2 or less, an average pore volume of from about 1.4 ml/g to about 3 ml/g, an average surface area from about 200 m²/g to about 950 m²/g, and a median particle size from about 4 μm to about 100 μm.

A process for polymerizing an olefin is also described. The process comprises contacting an olefin monomer with a catalyst system comprising a silica support and a catalyst precursor compound to form polyolefin particles. The silica support comprises a plurality of silica gel particles. Each particle comprises a rigid network of amorphous silica. The particles are spherical, single gel particles that have an average aspect ratio of about 1.2 or less, an average pore volume of from about 1.4 ml/g to about 3 ml/g, an average surface area from about 200 m²/g to about 950 m²/g, and a median particle size from about 4 μm to about 100 μm.

Other features and aspects of the present disclosure are discussed in greater detail below.

### BRIEF DESCRIPTION OF THE DRAWINGS

FIG. 1 shows a process flow diagram of a production process according to the present disclosure.

FIG. 2 shows an SEM image of the silica particles produced in Example 1.

FIG. 3 shows an SEM image of the silica particles produced in Example 2.

FIG. 4 shows an SEM image of the silica particles produced in Example 3.

FIG. 5 shows an SEM image of the polymer produced in Example 11.

FIG. 6 shows an SEM image of the polymer produced using the catalyst from Example 14B.

FIG. 7 shows an SEM image of the polymer produced using the catalyst from Example 15B.

FIG. 8 shows an SEM image of the polymer produced using the catalyst from Example 16B.

FIG. 9 shows an SEM image of the polymer produced using the catalyst from Example 16C.

FIG. 10 shows an SEM image of the polymer produced in Example 24.

FIG. 11 shows an SEM image of the polymer produced in Example 25.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the present disclosure is directed to an olefin catalyst system containing a silica support formed from spherical, single gel silica particles having a combination of particle size, pore volume, and surface area particularly suitable for use as a catalyst support. The spherical and single gel nature of the particles provides various advantages over conventional silica supports, such as those formed by a spray drying agglomeration process.

For example, catalysts containing single gel support particles tend to perform better in olefin polymerization processes than catalysts containing agglomerated support particles. As used herein, single gel particles refer to particles that are not formed from agglomerates of smaller particles. Agglomerates refer to products that combine particles that are held together by a variety of physical-chemical forces. More specifically, agglomerates are composed of a plurality of contiguous, constituent primary particles joined and connected at their points of contact. In contrast to agglomerates, a single gel particle cannot be separated into smaller particles without fracturing the particle.

Additionally, as the particles are highly spherical, when used in gas phase polymerization processes, they tend to be less prone to static buildup compared to less spherical particles. As such, using the catalysts described herein in gas phase olefin polymerization processes can reduce the amount or possibly eliminate the amount of antistat agents needed in the polymerization vessel.

As mentioned, the particles also have a combination of pore volume, surface area, and particle size particularly suitable for loading catalyst components and being used in olefin polymerization processes. For example, the particles have a relatively high surface area as determined by BET method using nitrogen adsorption, as described herein below. Generally, the average surface area of the particles is about 200 m²/g or greater, in some embodiments about 400 m²/g or greater, in some embodiments about 500 m²/g or greater, in some embodiments about 600 m²/g or greater, and in some embodiments, about 700 m²/g or greater. Typically, the average surface area of the particles is about 950 m²/g or less, in some embodiments about 800 m²/g or less, in some embodiments about 700 m²/g or less, in some embodiments about 600 m²/g or less, and in some embodiments, about 500 m²/g or less.

The particles also have a relatively high pore volume, as measured by nitrogen pore volume as described herein below. For example, the average pore volume of the particles is generally about 1.4 cc/g or greater, in some embodiments about 1.8 cc/g or greater, in some embodiments about 2 cc/g or greater, and in some embodiments, about 2.25 cc/g or greater. Typically, the pore volume is about 3 cc/g or less, in some embodiments about 2.6 cc/g or less, in some embodiments about 2.25 cc/g or less, and in some embodiments, about 2 cc/g or less.

The support particles can also have pore sizes suitable for the particular catalyst component loaded on the particles. For example, it can be desirable for some of the catalyst components or activators to enter the pores of the support. In this regard, the average pore diameter of the pores on the support particles, as measured by nitrogen porosimetry, can be relatively large, such as about 30 Angstroms or greater, in some embodiments about 50 Angstroms or greater, in some embodiments about 70 Angstroms or greater, in some embodiments about 100 Angstroms or greater, and in some embodiments about 150 Angstroms or greater. Typically, the average pore diameter is about 300 Angstroms or less, in some embodiments about 250 Angstroms or less, and in some embodiments, about 200 Angstroms or less.

Surface area is determined by BET nitrogen adsorption analysis after an activation of the samples under vacuum for 30 minutes at 400° C. The surface area is calculated from multi-point values of the nitrogen volumetric uptake during the adsorption branch at low [P/Po=˜0.05 to 0.15] partial pressures. The adsorption branch of the isotherm is stopped at a partial pressure of P/Po=0.995 and then the descending branch of the isotherm is measured. Nitrogen pore volumes are calculated by applying the Gurvich rule at P/Po=0.995. Pore diameters are reported as calculated BJH desorption average diameter.

In the past, it has been difficult to produce spherical, single gel silica particles having both a high pore volume and a high surface area. However, in some embodiments, the silica particles described herein have an average pore volume of about 2.3 cc/g or greater and an average surface area greater than about 350 m²/g. Such a combination allows for high catalyst loading on the support and high catalytic activity during polymerization.

The particle size sought to be imparted to the support particles depends upon the type of polymerization reaction in which the ultimate supported catalyst will be employed. Typically, the median particle size (D50), as measured by the Laser Diffraction method described herein below, of the particles is about 4 μm or greater, in some embodiments about 10 μm or greater, in some embodiments about 20 μm or greater, in some embodiments about 30 μm or greater, and in some embodiments, about 50 μm or greater. The median particle size is typically about 100 μm or less, in some embodiments about 75 μm or less, and in some embodiments, about 50 μm or less.

Regardless of their average size, the particles can have a relatively narrow particle size distribution. The breadth of the particle size distribution can be measured as a distribution span, defined by the following equation:

$$Distribution Span = \frac{( {D}_{90} - {D}_{10} )}{{D}_{50}} ,$$

wherein D₁₀, D₅₀, and D₉₀ represent the 10^{th}, 50^{th}, and 90^{th} percentile, respectively, of the particle size (diameter) distribution, i.e. a D₉₀ of 100 microns means that 90 volume % of the particles have diameters less than or equal to 100 microns. In this regard, the distribution span of the particles can be about 1.5 or less, in some embodiments about 1.45 or less, in some embodiments about 1.4 or less, in some embodiments about 1.3 or less, and in some embodiments from about 0.9 to about 1.25. The narrow particle size distribution also helps contribute to lowering static forces when used in gas phase polymerization processes.

The silica particles of the present disclosure can be prepared by a water-in oil type emulsion process. The present inventors unexpectedly discovered that the emulsion process described herein can produce silica particles having the unique properties described above. Additionally, it was found that the particle size, particle size distribution, pore size, pore volume, and surface area of the particles can be controlled by manipulating certain aspects of the emulsion process.

In the water-in-oil type emulsion process, a silica sol is first prepared by mixing an alkali silicate with an acid. The sol is then mixed with oil and a surfactant to generate an emulsion. In the emulsion formed during the process, the oil phase is continuous, and the sol forms stable spherical droplets dispersed in the oil phase. The pH can then be adjusted by adding a basic compound into the emulsion, which can help control the gelling process within the emulsion and the eventual pore structure.

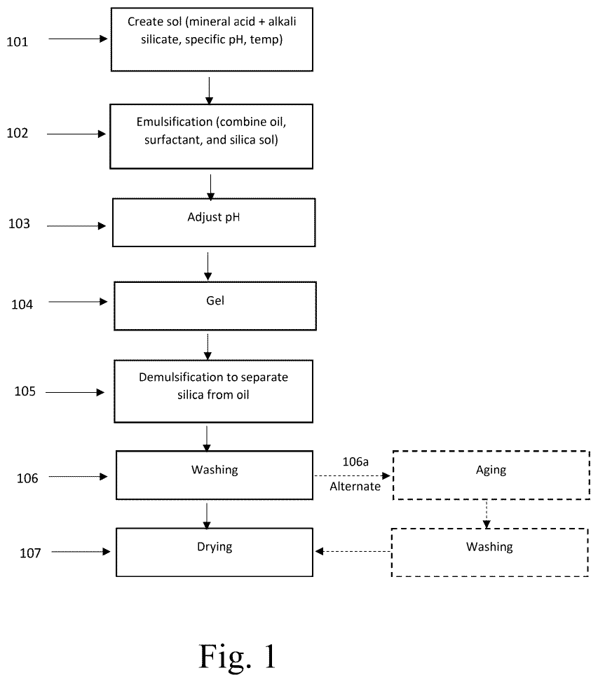

The process will be described in more detail with reference to FIG. 1. First, in step 101, a silica sol is formed first by combining a mineral acid and an alkali silicate. The alkali silicate can include sodium silicate, potassium silicate, lithium silicate, or the like. The alkali silicate is typically provided as an aqueous solution with a concentration from about 5 wt. % to about 50 wt. % (based on SiO₂ in the alkali silicate), such as from about 10 wt. % to about 35 wt. %. The mineral acid can be sulfuric acid, hydrochloric acid, nitric acid, or the like. In some embodiments, the alkali silicate is sodium silicate and the mineral acid is sulfuric acid. In other embodiments, the alkali silicate is sodium silicate and the mineral acid is hydrochloric acid. To form the sol, the alkali silicate can be added to a vessel containing the mineral acid. The flow rate is adjusted to obtain desired throughput on an industrial scale. For example, on a laboratory scale, the alkali silicate can be added to the mineral acid at a flow rate from about 1 ml/min to about 250 ml/min, such as from about 5 ml/min to about 200 ml/min, preferably from about 50 ml/min to about 200 ml/min. Alternatively, the alkali silicate and mineral acid can be combined at once by pouring one into the other. The concentration of the mineral acid is typically from about 10 wt. % to about 50 wt. %, in some embodiments from about 15 wt. % to about 40 wt. %, and in some embodiments, from about 18 wt. % to about 35 wt. %. The weight ratio of mineral acid to alkaline silicate preferably results in pH less than 7. The weight ratio of mineral acid to alkali silicate is generally from about 1:10 to about 2:1, in some embodiments from about 1:7 to about 1:1, and in some embodiments, from about 1:5 to about 1:2.

In some embodiments, the concentration and amounts of aqueous alkali silicate and mineral acid are selected in order to reach a specified pH value. For example, in some embodiments, the pH of the resulting mixture is controlled to remain below about 4, such as below about 3, such as below about 1.5. The pH of the resulting mixture is typically about 1 or greater.

During the sol formation step, the temperature should be controlled to a relatively low temperature. For example, in some embodiments, the temperature is controlled to be about 40° C. or less, in some embodiments about 30° C. or less, and in some embodiments, about 20° C. or less.

To form the sol, the mineral acid and alkali silicate can be continuously mixed in the vessel using a mixer, such as a static or in-line mixer. The mixer can operate at any suitable speed for a time period sufficient to form a sol. For example, in some embodiments, the mixture can be mixed for a time period from about 2 min to about an hour, such as from about 5 min to about 45 min, such as from about 10 min to about 40 min.

After the sol is formed, it is pumped into or otherwise combined with an oil and a surfactant to form the water-in-oil emulsion in step 102. The oil and surfactant can be combined to form a surfactant/oil mixture and the mixture is added to the sol. The amount of surfactant can be controlled to form stable spherical silica sol droplets. In some embodiments, the surfactant is present in the mixture in an amount ranging from about 3 wt. percent to about 25 wt. percent of the total surfactant/oil mixture. Preferably, the surfactant is present in the mixture in an amount ranging from about 5 wt. percent to about 15 wt. percent. Alternatively, the oil and surfactant are added individually to the sol in amounts sufficient to provide a surfactant/oil mixture having the above described wt. percent.

The oil is not particularly limited other than that it should be nonreactive and immiscible with the aqueous alkali silicate and the mineral acid. Exemplary oils include n-octane, gasoline, kerosene, isoparaffinic hydrocarbon oils and the like, alicyclic hydrocarbons such as cyclononane, cyclodecane and the like, aromatic hydrocarbons such as toluene, xylene, ethylbenzene, tetralin and the like, and mixtures of alkanes such as mineral oil.

A broad range of surfactants can be used, including: glycerol monocaprylate, glycerol monolaurate, glycerol mono/dicocoate, glycerol dilaurate, glycerol monostearate, glycerol monostearate distilled, glycerol distearate, glycerol monooleate, glycerol dioleate, glycerol trioleate, glycerol monoisostearate, glycerol monoricinoleate, glycerol monohydroxystearate, POE glycerol monostearate, acetylated glycerol monostearate, succinylated glycerol monostearate, diacetylated glycerol monostearate tartrate, modified glycerol phthalate resin, triglycerol monostearate, triglycerol monooleate, triglycerol monoisostearate, decaglycerol tetraoleate, decaglycerol decastearate, pentaerythritol monolaurate, pentaerythritol monostearate, pentaerythritol distearate, pentaerythritol tetrastearate, pentaerythritol monooleate, pentaerythritol dioleate, pentaerythritol trioleate, pentaerythritol tetraricinoleate, sorbitan monolaurate, POE sorbitan monolaurate, sorbitan monopalmitate, POE sorbitan monopalmitate, sorbitan monostearate, POE sorbitan monostearate, sorbitan tristearate, POE sorbitan tristearate, sorbitan monooleate, POE sorbitan monooleate, sorbitan sesquioleate, sorbitan trioleate, POE sorbitan trioleate, POE sorbitol hexaoleate, POE sorbitol oleate laurate, POE sorbitol polyoleate, POE sorbitol, beeswax-ester, sucrose monolaurate, sucrose cocoate, sucrose monomyristate, sucrose monopalmitate, sucrose dipalmitate, sucrose monostearate, sucrose distearate, sucrose monooleate, sucrose dioleate, lauryl lactate, cetyl lactate, sodium lauryl lactate, sodium stearoyl lactate, sodium isostearoyl-2-lactylate, sodium stearoyl-2-lactylate, calcium stearoyl-2-lactylate, sodium capryl lactate, lauryl alcohol, and cetyl alcohol.

In one embodiment, the surfactant comprises at least one sorbitan ester. The sorbitan esters include sorbitan fatty acid esters wherein the fatty acid component of the ester comprises a carboxylic acid of about 10 to about 100 carbon atoms, and in one embodiment, about 12 to about 24 carbon atoms. Sorbitan is a mixture of anhydrosorbitols, principally 1,4-sorbitan and isosorbide (Formulas I and II):

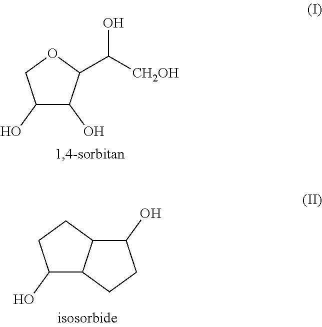 [SMILES: OCC(O)C1OCC(O)C1O ; OC1CCC2C(O)CCC12]

Sorbitan, (also known as monoanhydrosorbitol, or sorbitol anhydride) is a generic name for anhydrides derivable from sorbitol by removal of one molecule of water. The sorbitan fatty acid esters of this invention are a mixture of partial esters of sorbitol and its anhydrides with fatty acids. These sorbitan esters can be represented by the structure below which may be any one of a monoester, diester, triester, tetraester, or mixtures thereof (Formula III):

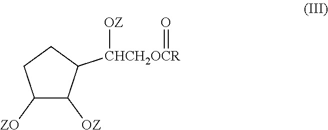

In formula (III), each Z independently denotes a hydrogen atom or C(O)R—, and each R mutually independently denotes a hydrocarbyl group of about 9 to about 99 carbon atoms, more preferably about 11 to about 23 carbon atoms. Examples of sorbitan esters include sorbitan stearates and sorbitan oleates, such as sorbitan stearate (i.e.,monostearate), sorbitan distearate, sorbitan tristearate, sorbitan monooleate and sorbitan sesquioleate. The sorbitan esters also include polyoxyalkylene sorbitan esters wherein the alkylene group has about 2 to about 30 carbon atoms. These polyoxyalkylene sorbitan esters can be represented by Formula IV:

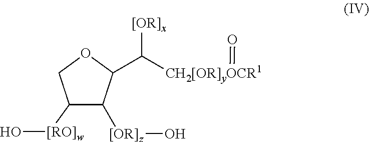

wherein in Formula IV, each R independently is an alkylene group of about 2 to about 30 carbon atoms; R′ is a hydrocarbyl group of about 9 to about 99 carbon atoms, more preferably about 11 to about 23 carbon atoms; and w, x, y and z represent the number of repeat oxyalkylene units. For example, ethoxylation of sorbitan fatty acid esters leads to a series of more hydrophilic surfactants, which is the result of hydroxy groups of sorbitan reacting with ethylene oxide. One principal class of these ethoxylated sorbitan esters are those containing about 2 to about 80 ethylene oxide units, and in one embodiment from about 2 to about 30 ethylene oxide units, and in one embodiment about 4, in one embodiment about 5, and in one embodiment about 20 ethylene oxide units. Typical examples are polyoxyethylene(hereinafter “POE”) (20) sorbitan tristearate, POE (4) sorbitan monostearate, POE (20) sorbitan trioleate, POE (5) sorbitan monooleate, and POE (80) sorbitan monooleate. As used herein the number within the parentheses refers to the number of ethylene oxide units present in the composition.

Useful surfactants of the types listed in the above table can be generically represented by the following classes of chemical compounds, members of which are commercially available and are suitable provided that they are used in accordance with the teachings herein such that stable emulsions are produced:
(a) sorbitol esters of the general formula

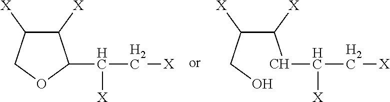

in which: the radicals X are identical to or different from one another and are each OH or R¹COO⁻; where R¹ is a linear or branched, saturated or unsaturated, aliphatic hydrocarbon radical optionally substituted by hydroxyls and having from 7 to 22 carbon atoms, provided that at least one of said radicals X is R¹COO⁻,
(b) fatty acid esters of the general formula:

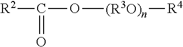

in which: R² is a linear or branched, saturated or unsaturated, aliphatic hydrocarbon radical optionally substituted by hydroxyl groups and having from 7 to 22 carbon atoms; R³ is a linear or branched C₁-C₁₀ alkylene; n is an integer greater than or equal to 6; and R⁴ is H, linear or branched C₁-C₁₀ alkyl or

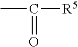

where R⁵ is as defined above for R²; and
(c) polyalkoxylated alkylphenol of the general formula

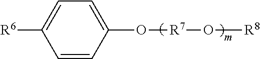

in which: R⁶ is a linear or branched C₁-C₂₀ alkyl; m is an integer greater than or equal to 8; and R⁷ and R⁸ are respectively as defined above for R³ and R⁴ of formula (II).

Typically, the weight ratio of the sol to oil and surfactant mixture can be from about 1:5 to about 5:1, such as from about 1:4 to about 4:1, such as from about 1:3 to about 2:1, such as from about 1:2 to about 2:1. In some embodiments, the oil is a mineral oil and the surfactant is a sorbitan ester, such as a sorbitan monooleate and the weight ratio ranges from 1:2 to 2:1.

The temperature can be controlled during the emulsion forming step in order to obtain the desired silica sol droplet size. For example, the temperature can be maintained above about 30° C., such as from about 40° C. to about 80° C., such as from about 50° C. to about 65° C., while forming the emulsion.

The mixing speed should sufficiently high to form a stable emulsion, i.e an emulsion that does not separate upon standing at room temperature within a desired time period, and to obtain the desired silica sol droplet size. Such mixing speed may be accomplished using an overhead type mixer, e.g. a Dispermat mixture, or an in-line type mixer, e.g. Silverson mixer. After the sol is fully pumped into the reaction vessel or otherwise fully mixed, the emulsion can be continually mixed for a time period sufficient to maintain a stable emulsion. For example, in some embodiments, mixing can continue for a time period from about 1 min to about an hour.

Following the formation of the emulsion, the process proceeds to step 103 in which the pH of the emulsion is optionally adjusted. The pH can be adjusted using a basic compound. For example, any base known or hereafter discovered can be employed in the various embodiments described herein for adjusting the pH. In various embodiments, the base can be selected from the group consisting of NaOH, aqueous ammonia, ammonium hydroxides (e.g., NH₄OH), KOH, Na₂CO₃, TMAOH (tetramethylammonium hydroxide), NaAlO₂, and mixtures thereof. Additionally, the base employed can be in the form of a solution having a concentration in the range of from 0.2 to 50 percent. In various embodiments, the above-mentioned base can have a pH of at least 7, such as from about 8 to about 14, such as from about 9 to about 13. The amount of the basic compound used is determined by the target pH to be reached. For example, in some embodiments, the basic compound is added until the pH reaches a value of about 3 or greater, in some embodiments about 4 or greater, in some embodiments about 5 or greater, in some embodiments about 6 or greater, in some embodiments about 7 or greater, and in some embodiments, about 8 or greater. The pH typically reaches about 12 or less, in some embodiments about 11 or less, in some embodiments about 10 or less, and in some embodiments, about 9 or less. For instance, in some embodiments, ammonium hydroxide is added until the pH reaches from about 3 to about 10, such as from about 5 to about 9. The emulsion can be continuously mixed as the basic compound is added and for a period of time thereafter to promote pH stabilization. The mixing speed can optionally be reduced at this stage. For example, in some embodiments, the mixing speed is reduced to a speed from about 10% to about 60% of the mixing speed used to form the emulsion.

It should be understood that the pH is not necessarily adjusted and that step 103 is optional. The pore properties of the resulting silica particles can be controlled by adjusting the pH of the emulsion during gelation. As such, the pH should be adjusted to the level necessary to obtain the desired pore properties. Thus, in some instances, the pH will not need to be adjusted at all.

Following the optional pH adjusting step, the process can proceed to step 104 in which the silica is gelled. The gelling process can comprise optionally adding water into the emulsion and increasing the temperature while optionally continuously mixing. The volume of water added at this stage is not critical but can be from about 0.25 to about 10 times the volume of the mixture within the vessel. In other embodiments, no water is added.

The temperature for gelling can range from about 50° C. to about 95° C., in some embodiments from about 75° C. to about 85° C., such as from about 75° C. to about 85° C. The mixing speed can be maintained at a similar speed as in step 103. This temperature and mixing speed can be maintained for a period of time sufficient to allow the silica to gel. For example, in some embodiments, the gelling time can be from about 20 min to about 2 hours, such as from about 30 min to about 90 min. In some embodiments, the obtained silica gel can be aged prior to separation, for example, by Ostwald ripening, in which the obtained silica gel is maintained at a temperature from about 50° C. to about 95° C., in some embodiments from about 70° C. to about 90° C., and in some embodiments, from about 75° C. to about 85° C. for a time period from about 10 minutes to about 10 hours, in some embodiments from about 30 minutes to about 5 hours, and in some embodiments, from about 45 minutes to about 2 hours. The pH can optionally be adjusted during the aging process. In this manner, the surface area and pore diameter can be adjusted in situ and the gel network can be strengthened.

Following the gelling step, the process can proceed to separation in step 105. Any suitable method can be used to separate the solid silica gel particles from the oil and water phases of the mixture. For example, in some embodiments, the mixing is discontinued so that the oil and surfactant separate from the formed silica particles. In some embodiments, the solid particles can be filtered out of the mixture.

The obtained silica particles can then optionally be washed in step 106, for example by stirring them in an acid, water, and/or alcohol. The particles can then be dried in step 107 using any suitable method. For example, in some embodiments, the particles can be dried at a temperature and time sufficient to remove the desired amount of moisture. In some embodiments, the particles can be dried in a vacuum oven at a temperature from about 40° C. to about 80° C. for about 30 minutes to 24 hours. In some embodiments, the particles can be dried in a conventional oven at a temperature from about 90° C. to about 130° C. for about 30 minutes to about 24 hours. In some embodiments, the particles can be dried using spray dryer. In other embodiments, the particles can be dried by flash drying or by co-evaporation using an organic solvent.

In some embodiments, to facilitate the separation of the oil and surfactant from the emulsion, the emulsion is demulsified by adding a demulsifying agent. In some embodiments, the demulsifying agent is water or an acid, such as a mineral acid. For example, in some embodiments, deionized water or aqueous mineral acid is added to the emulsion as a demulsifying agent. For example, when aqueous sulfuric acid composition is employed as a demulsifier, the concentration of the sulfuric acid can be from about 1 wt. % to about 30 wt. %, in some embodiments from about 5 wt. % to about 15 wt. % of the total aqueous composition. The demulsifying agent can be added to the emulsion in a weight ratio from about 1:5 to about 5:1 relative to the weight of the emulsion, in some embodiments in a weight ratio from about 1:2 to about 1:1.

The demulsification can occur at an elevated temperature. For example, the temperature can be from about 50° C. to about 95° C., in some embodiments from about 60° C. to about 90° C., and in some embodiments, from about 70° C. to about 80° C. During demulsification, the mixture can optionally by agitated by any suitable means. For example, in some embodiments, after the demulsifying agent is added, the mixture is agitated at an elevated temperature for about 30 minutes to about 5 hours, such as from about 1 hour to about 3 hours. In other embodiments, the mixture is kept at an elevated temperature without agitation for about 30 minutes to about 5 hours, such as from about 1 hour to about 3 hours.

Following demulsification, the particles can be separated from the rest of the mixture by any suitable means. For example, in some embodiments, the mixture can be transferred to a separatory funnel to separate the aqueous phase from the oil phase. The silica particles can then be separated from the rest of the liquid. In some embodiments, for example, the particles can be filtered and redispersed repeatedly as necessary.

After separation, the particles can optionally be aged as shown in FIG. 1, step 106a. The particles can be aged at an elevated temperature in an ammonia solution. In some embodiments, the particles are redispersed in an aqueous medium, heated, and combined with ammonium hydroxide for a suitable time period. The pH of the redispersed particles in the aqueous medium can be from about 1 to about 5, such as from about 2 to about 4. The temperature for aging can be from about 50° C. to about 95° C., in some embodiments from about 70° C. to about 90° C., and in some embodiments, from about 75° C. to about 85° C. Ammonium hydroxide can be added until the pH of the solution reaches from about 6 to about 9, such as from about 7 to about 8. In some embodiments, the particles are aged for a time period from about 10 minutes to about 10 hours, in some embodiments from about 30 minutes to about 5 hours, and in some embodiments, from about 45 minutes to about 2 hours.

If the particles are aged in such a solution, they can be filtered and dried afterward. For example, in some embodiments the particles can be filtered from the ammonia solution, redispersed in water as necessary, and then filtered and dried to remove water and any solvent to form a powder. In some embodiments, after being filtered from the ammonia solution, the particles are redispersed in deionized water and then dried at an elevated temperature for a suitable time period. Any suitable temperature can be used to dry the particles. In some embodiments, for example, the particles are dried at a temperature from about 50° C. to about 250° C., in some embodiments from about 80° C. to about 200° C., and in some embodiments, from about 100° C. to about 150° C. for a time period from about 1 hour to about 48 hours, such as from about 5 hours to about 24 hours.

The emulsion process used to form the silica particles can provide additional advantages over conventional silica supports. For instance, in conventional spray dried silica supports, the milling process tends to produce very small silica particles, known as “fines.” Even when the silica particles are highly classified to remove fines, it is difficult to prevent some of the fines from remaining attached to the support particles and entering the polymerization reactor, causing static and fouling, particularly in gas phase reactors. However, advantageously, the silica support of the present disclosure can have a very small content of fines, as no milling process is required when using the described emulsion processes. For example, in some embodiments, the number percentage of silica particles having a particle size of 1 μm or less is about 7% or less, in some embodiments, about 4% or less, and in some embodiments, from about 2% to less than 1%.

During the above process, the silica gel particles formed within the droplets of the emulsion to provide porous spherical silica particles. Each particle contains a rigid network of amorphous silica. As such, the particles tend to be highly spherical. One method for measuring the sphericity of particles is to take an image of a number of particles and calculate the aspect ratio of each particle using the largest diameter and the smallest diameter of each particle that can be determined from the image. Then, an average aspect ratio of the particles can be calculated using the aspect ratios of the individual particles. Thus, particles having a low aspect ratio are more spherical than particles having a higher aspect ratio. In this regard, the particles formed by either of the above processes are highly spherical and can have a low average aspect ratio, such as about 1.2 or less, in some embodiments about 1.17 or less, in some embodiments about 1.15 or less, in some embodiments about 1.12 or less, and in some embodiments, about 1.1 or less. For example, in some embodiments, at least 75% of the particles have an aspect ratio of about 1.2 or less, such as about 1.1 or less. In some embodiments, at least 50% of the particles have an aspect ratio of about 1.1 or less. The aspect ratio is typically 1.0 or greater.

Such highly spherical support particles can help produce polymer particles having good morphology and high bulk density. For example, polyolefin particles produced using the catalyst systems described herein can have settled bulk densities greater than 0.4 g/cc. Additionally, the average aspect ratio of the polyolefin particles produced can be less than about 1.2.

As explained above, the silica support can be used in a variety of different catalyst forms. Ziegler-Natta, metallocene, and chromium catalysts, co-catalysts, and activator components can be impregnated in and on the supports described herein. For example, the catalyst components sought to be impregnated into the supports can be dissolved or suspended in an organic solvent to which the support is added and slurried. The solvent can then be evaporated. Evaporation can take place in a conical dryer that avoids applying high stress to the core material. Many variations on this theme are possible and the particular impregnation technique will depend on the particular catalyst system to be employed, as is well known in the art.

“Ziegler-Natta” catalysts are conventionally understood to comprise a transition metal (Group IIIB through VIIIB) halide, alkyl, aryl, or alkoxy compounds, and mixtures thereof in combination with Group I through III elements of the Periodic Table. A typical example is TiCl₄ and AlEt₃. Preferred Zeigler-Natta systems are those employing a complex of magnesium chloride/titanium halide or alkoxy compounds and an aluminum alkyl deposited on a silica support. Methods of producing the catalysts are known in the art. Electron donors may also be used in Zeigler-Natta catalyst systems of the present invention and include, esters, ethers, amines, silanes and alcohols, and mixtures thereof.

One suitable process for providing a silica supported Ziegler-Natta type catalyst is described in U.S. Pat. No. 5,633,419, which is incorporated herein by reference.

For example, the Ziegler-Natta catalyst composition can include a magnesium halide, a transition metal compound, an alkylaluminum cocatalyst, and an electron donor compound. These components can be incorporated into or supported on the silica support. For example, a catalyst component can be formed by impregnating the silica support with a solution of a magnesium halide or a magnesium containing precursor which can be converted into a magnesium halide upon halogenation.

The silica support can be impregnated by immersing the support particles in a magnesium halide solution, such as magnesium chloride, magnesium bromide, magnesium iodide, and magnesium fluoride, dissolved in a polar solvent, agitating the solution for a sufficient period of time, and then removing the solvent.

Alternatively, the support can be impregnated with a hydrocarbon soluble magnesium compound of the formula R₂₋ₙMgXₙ·ₓMR′_{y} wherein each R independently is a hydrocarbyl group having from 1 to 20 carbon atoms, each X independently is halo or hydrocarbyloxy with from 1 to 20 carbon atoms in the hydrocarbyl part thereof, n is from 0 to 2 with the proviso that if X is halo n is at most 1, M is aluminum, zinc or boron, each R′ independently is hydrogen, hydrocarbyl or hydrocarbyloxy with from 1 to 20 carbon atoms in the hydrocarbyl part thereof, y has a value equal to the valence of M, and x has a value from 0 to 10. Following impregnating the silica support with the hydrocarbon soluble magnesium compound, the magnesium halide can be formed by halogenation.

In some embodiments, the halogenating agent is selected from the group consisting of alkyl aluminum halides, advantageously alkyl aluminum sesqui-or dihalides, hydrogen halides, silicon halides, and boron halides.

A transition metal compound can then be added to the supported magnesium halide component in any manner known in the art. The transition metal compound can be a Group 4 or 5 transition metal compound such as a halide, hydrocarbyloxide or mixed halide/hydrocarbyloxide of titanium, zirconium, hafnium, or vanadium. For example, Suitable Group 4 transition metal compounds are represented by the formula MX₄₋ₐ (OR)ₐ, wherein M is titanium, zirconium or hafnium, each R is independently an alkyl group having from 1 to about 20, preferably from about 1 to about 10, more preferably from 2 to about 8 carbon atoms; X is a halogen atom, preferably chlorine; and a has a value from 0 to 4. Suitable Group 5 transition metal compounds preferably are vanadium compounds such as those represented by the formulas VX₄ and V(O)X₃, wherein each X is independently OR or a halide atom, preferably chloride, and, each R is independently an alkyl group having from 1 to about 20, preferably from about 2 to about 8, more preferably from about 2 to about 4, carbon atoms.

Various different types of internal electron donors may also incorporated into the catalyst component in any suitable manner. In one embodiment, the internal electron donor is an aryl diester, such as a phenylene-substituted diester. In one embodiment, the internal electron donor may have the following chemical structure:

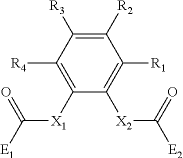

wherein R₁ R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

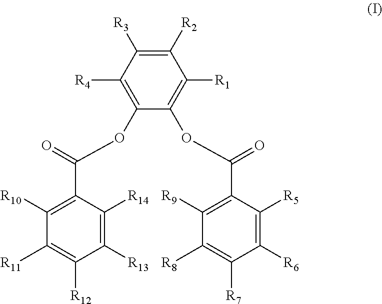

In an embodiment, structure (I) includes R₁ and R₃ that is an isopropyl group. Each of R₂, R₄ and R₅-R₁₄ is hydrogen.

In an embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group. Each of R₂, R₄, and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ a t-butyl group. Each of R₇ and R₁₂ is an ethoxycarbonyl group, Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄, and R₅-R₁₄ is hydrogen.

In an embodiment, structure (I) includes R₁ and R₃, each of which is a sec-butyl group. Each of R₂, R₄, and R₅-R₁₄ is hydrogen.

In an embodiment, structure (I) includes R₁ and R₄ that are each a methyl group. Each of R₂, R₃, R₅-R₉, and R₁₀-R₁₄ is hydrogen.

In an embodiment, structure (I) includes R₁ that is a methyl group. R₄ is an i-propyl group. Each of R₂, R₃, R₅-R₉, and R₁₀-R₁₄ is hydrogen.

In an embodiment, structure (I) includes R₁, R₃, and R₄, each of which is an i-propyl group. Each of R₂, R₅-R₉, and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

In addition to the catalyst component as described above, the Ziegler-Natta catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, and n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

Alternatively, the olefin polymerization catalyst system can include a catalyst precursor compound, such as a metallocene component, and an activator loaded on the silica support. Metallocene catalysts can include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom.

The Cp ligands are one or more rings or ring system(s), at least a portion of which includes π-bonded systems, such as cycloalkadienyl ligands and heterocyclic analogues. The ring(s) or ring system(s) typically comprise atoms selected from Groups 13 to 16 atoms, and, in some embodiments, the atoms that make up the Cp ligands are selected from carbon, nitrogen, oxygen, silicon, sulfur, phosphorous, germanium, boron, aluminum, and combinations thereof, where carbon makes up at least 50% of the ring members. For example, the Cp ligand(s) may be selected from substituted and unsubstituted cyclopentadienyl ligands and ligands isolobal to cyclopentadienyl. Non-limiting examples of such ligands include cyclopentadienyl, cyclopentaphenanthrenyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄ Ind”), substituted versions thereof (as discussed and described in more detail below), and heterocyclic versions thereof.

The metal atom “M” of the metallocene compound may be selected from Groups 3 through 12 atoms and lanthanide Group atoms; or may be selected from Groups 3 through 10 atoms; or may be selected from Sc, Ti, Zr, Hf, V, Nb, Ta, Mn, Re, Fe, Ru, Os, Co, Rh, Ir, and Ni; or may be selected from Groups 4, 5, and 6 atoms; or may be Ti, Zr, or Hf atoms; or may be Hf; or may be Zr. The oxidation state of the metal atom “M” can range from 0 to +7; or may be +1, +2, +3, +4 or +5; or may be +2, +3 or +4. The groups bound to the metal atom “M” are such that the compounds described below in the structures and structures are electrically neutral, unless otherwise indicated. The Cp ligand(s) forms at least one chemical bond with the metal atom M to form the “metallocene catalyst component.” The Cp ligands are distinct from the leaving groups bound to metal atom M in that they are not highly susceptible to substitution/abstraction reactions.

In one embodiment, the metallocene catalyst may be represented by the following formula:

(C₅Rₓ)_{y}R′ₓ(C₅Rₘ)MQ_{n-y-1}

In the formula, M is a metal of Groups IIIB to VIII of the Periodic Table of the Elements; (C₅Rₓ) and (C₅Rₘ) are the same or different cyclopentadienyl or substituted cyclopentadienyl groups bonded to M; R is the same or different and is hydrogen or a hydrocarbyl radical such as alkyl, alkenyl, aryl, alkylaryl, or arylalkyl radical containing from 1 to 20 carbon atoms or two carbon atoms are joined together to form a C4-C6 ring; R′is a C1-C4 substituted or unsubstituted alkylene radical, a dialkyl or diaryl germanium or silicon, or an alkyl or aryl phosphine or amine radical bridging two (C₅Rₓ)and (C₅Rₘ) rings; Q is a hydrocarbyl radical such as aryl, alkyl, alkenyl, alkylaryl, or aryl alkyl radical having from 1-20 carbon atoms, hydrocarboxy radical having from 1-20 carbon atoms or halogen and can be the same or different from each other; z is 0 or 1; y is 0, 1 or 2; z is 0 when y is 0; n is 0, 1, 2, 3, or 4 depending upon the valence state of M; and n-y is ≥1.

Illustrative but non-limiting examples of the metallocenes represented by the above formula are dialkyl metallocenes such as bis(cyclopentadienyl)titanium dimethyl, bis(cyclopentadienyl)titanium diphenyl, bis(cyclopentadienyl)zirconium dimethyl, bis(cyclopentadienyl)zirconium diphenyl, bis(cyclopentadienyl)hafnium dimethyl and diphenyl, bis(cyclopentadienyl)titanium di-neopentyl, bis(cyclopentadienyl)zirconium di-neopentyl, bis(cyclopentadienyl)titanium dibenzyl, bis(cyclopentadienyl)zirconium dibenzyl, bis(cyclopentadienyl)vanadium dimethyl; the mono alkyl metallocenes such as bis(cyclopentadienyl)titanium methyl chloride, bis(cyclopentadienyl)titanium ethyl chloride, bis(cyclopentadienyl)titanium phenyl chloride, bis(cyclopentadienyl)zirconium methyl chloride, bis(cyclopentadienyl)zirconium ethyl chloride, bis(cyclopentadienyl)zirconium phenyl chloride, bis(cyclopentadienyl)titanium methyl bromide; the trialkyl metallocenes such as cyclopentadienyl titanium trimethyl, cyclopentadienyl zirconium triphenyl, and cyclopentadienyl zirconium trineopentyl, cyclopentadienyl zirconium trimethyl, cyclopentadienyl hafnium triphenyl, cyclopentadienyl hafnium trineopentyl, and cyclopentadienyl hafnium trimethyl; monocyclopentadienyls titanocenes such as, pentamethylcyclopentadienyl titanium trichloride, pentaethylcyclopentadienyl titanium trichloride; bis(pentamethylcyclopentadienyl)titanium diphenyl, the carbene represented by the formula bis(cyclopentadienyl)titanium=CH₂ and derivatives of this reagent; substituted bis(cyclopentadienyl)titanium (IV) compounds such as: bis(indenyl)titanium diphenyl or dichloride, bis(methylcyclopentadienyl)titanium diphenyl or dihalides; dialkyl, trialkyl, tetra-alkyl and penta-alkyl cyclopentadienyl titanium compounds such as bis(1,2-dimethylcyclopentadienyl)titanium diphenyl or dichloride, bis(1,2-diethylcyclopentadienyl)titanium diphenyl or dichloride; silicon, phosphine, amine or carbon bridged cyclopentadiene complexes, such as dimethyl silyldicyclopentadienyl titanium diphenyl or dichloride, methyl phosphine dicyclopentadienyl titanium diphenyl or dichloride, methylenedicyclopentadienyl titanium diphenyl or dichloride and other dihalide complexes, and the like; as well as bridged metallocene compounds such as isopropyl(cyclopentadienyl)(fluorenyl)zirconium dichloride, isopropyl(cyclopentadienyl) (octahydrofluorenyl)zirconium dichloride diphenylmethylene(cyclopentadienyl)(fluorenyl) zirconium dichloride, diisopropylmethylene (cyclopentadienyl)(fluorenyl)zirconium dichloride, diisobutylmethylene(cyclopentadienyl)(fluorenyl) zirconium dichloride, ditertbutylmethylene (cyclopentadienyl)(fluorenyl)zirconium dichloride, cyclohexylidene(cyclopentadienyl)(fluorenyl) zirconium dichloride, diisopropylmethylene (2,5-dimethylcyclopentadienyl)(fluorenyl)zirconium dichloride, isopropyl(cyclopentadienyl)(fluorenyl) hafnium dichloride, diphenylmethylene (cyclopentadienyl) (fluorenyl)hafnium dichloride, diisopropylmethylene(cyclopentadienyl) (fluorenyl)hafnium dichloride, diisobutylmethylene(cyclopentadienyl) (fluorenyl)hafnium dichloride, ditertbutylmethylene(cyclopentadienyl) (fluorenyl)hafnium dichloride, cyclohexylidene(cyclopentadienyl)(fluorenyl)hafnium dichloride, diisopropylmethylene(2,5-dimethylcyclopentadienyl) (fluorenyl)hafnium dichloride, isopropyl(cyclopentadienyl)(fluorenyl)titanium dichloride, diphenylmethylene(cyclopentadienyl) (fluorenyl)titanium dichloride, diisopropylmethylene(cyclopentadienyl) (fluorenyl)titanium dichloride, diisobutylmethylene(cyclopentadienyl) (fluorenyl)titanium dichloride, ditertbutylmethylene(cyclopentadienyl) (fluorenyl)titanium dichloride, cyclohexylidene(cyclopentadienyl) (fluorenyl)titanium dichloride, diisopropylmethylene(2,5 dimethylcyclopentadienyl fluorenyl)titanium dichloride, racemic-ethylene bis (1-indenyl) zirconium (IV) dichloride, racemic-ethylene bis (4,5,6,7-tetrahydro-1-indenyl) zirconium (IV) dichloride, racemic-dimethylsilyl bis (1-indenyl) zirconium (IV) dichloride, racemic-dimethylsilyl bis (4,5,6,7-tetrahydro-1-indenyl) zirconium (IV) dichloride, racemic-1,1,2,2-tetramethylsilanylene bis (1-indenyl) zirconium (IV) dichloride, racemic-1,1,2,2-tetramethylsilanylene bis (4,5,6,7-tetrahydro-1-indenyl) zirconium (IV), dichloride, ethylidene (1-indenyl tetramethylcyclopentadienyl) zirconium (IV) dichloride, racemic-dimethylsilyl bis (2-methyl-4-t-butyl-1-cyclopentadienyl) zirconium (IV) dichloride, racemic-ethylene bis (1-indenY1)hafnium (IV) dichloride, racemic-ethylene bis (4,5,6,7-tetrahydro-1-indenyl) hafnium (IV) dichloride, racemic-dimethylsilyl bis (1-indenyl) hafnium (IV) dichloride, racemic-dimethylsilyl bis(4,5,6,7-tetrahydro-1-indenyl) hafnium (IV) dichloride, racemic-1,1,2,2-tetramethylsilanylene bis (1-indenyl) hafnium (IV) dichloride, racemic-1,1,2,2-tetramethylsilanylene bis (4,5,6,7-tetrahydro-1-indenyl) hafnium (IV), dichloride, ethylidene (1-indenyl-2,3,4,5-tetramethyl-1-cyclopentadienyl) hafnium (IV) dichloride, racemic-ethylene bis (1-indenyl) titanium (IV) dichloride, racemic-ethylene bis (4,5,6,7-tetrahydro-1-indenyl) titanium (IV) dichloride, racemic-dimethylsilyl bis (1-indenyl) titanium (IV) dichloride, racemic-dimethylsilyl bis (4,5,6,7-tetrahydro-1-indenyl) titanium (IV) dichloride, racemic-1,1,2,2-tetramethylsilanylene bis (1-indenyl) titanium (IV) dichloride racemic-1,1,2,2-tetramethylsilanylene bis (4,5,6,7-tetrahydro-1-indenyl) titanium (IV) dichloride, and ethylidene (1-indenyl-2,3,4,5-tetramethyl-1-cyclopentadienyl) titanium IV) dichloride.

An activator may also be used with the metallocene catalyst. The activator, for instance, may be an aluminoxane, borane, or borate compound. Activators that may be used include those that have the following general formula:

M³M⁴ᵥX²_{c}R³_{b-c}

wherein M³ is a metal of Groups IA, IIA and IIIA of the periodic table; M⁴ is a metal of Group IA of the Periodic table; v is a number from 0 to 1; each X² is any halogen; c is a number from 0 to 3; each R³ is a monovalent hydrocarbon radical or hydrogen; b is a number from 1 to 4; and wherein b-c is at least 1.

Compounds having only one Group IA, IIA or IIIA metal which are suitable for the practice of the invention include compounds having the formula:

M³R³ₖ

wherein: M³ is a Group IA, IIA or IIIA metal, such as lithium, sodium, beryllium, barium, boron, aluminum, zinc, cadmium, and gallium; k equals 1, 2 or 3 depending upon the valency of M³ which valency in turn normally depends upon the particular group (i.e., IA, IIA or IIIA) to which M³ belongs; and each R³ may be any monovalent hydrocarbon radical. Examples of suitable R³ groups include any of the R³ groups aforementioned in connection with formula (V). In some embodiments, the activator is selected from methylaluminoxane, tris-perfluorophenyl borate, and trityl tetra-perfluorophenyl borate.

Advantageously, the silica support described herein can accommodate relatively high activator loading. For example, in some embodiments, an organoaluminum compound is loaded on the support such that the catalyst system contains from about 10 wt. % Al or greater. Typically, the Al loading is about 25 wt. % or less.

The olefin polymerization catalyst system may further comprise a chromium compound supported by the silica support or incorporated into the silica support. More specifically, a chromium catalyst can be prepared by contacting the silica support with a chromium compound, such as a salt, that is at least partially soluble in water or an organic liquid media. In some embodiments, an aqueous solution or suspension of the chromium salt can be contacted with an aqueous slurry of the support particles.

The chromium compound suitable for use in forming the subject catalyst composition can be selected from any chromium salt of an inorganic or organic acid that has some degree of solubility with respect to the media used to mix the salt with the silica, as applicable. The preferred medium is water. For example, suitable inorganic salts are chromium halides, such as chromium dichloride, chromium chloride hexahydrate, chromium dibromide, chromium bromide hexahydrate, chromium tribromide chromium difluoride; as well as chromium nitrate; chromic anhydride, chromium phosphate; chromium^{(II)} sulfate; chromium sulfate pentadecahydrate and octadecahydrate; chromium orthophosphate; and the like and mixtures thereof.

Organic chromium compounds suitable as a chromium atom source for forming the present catalyst include salts of organic acids, such as chromium acetate, chromium acetate hydrate, chromium acetylacetonate, chromium proprionate, chromium oxalate hydrate, chromium oxalate hexahydrate; amine complexes such as hexamine chromium III chloride; chloropentamine chromium chloride; hexaurea chromium III fluorosilicate; chromocene and the like and mixtures thereof.

Certain chromium compounds found useful herein have greater solubility in organic solvents. These compounds include, for example, chromocene, bis-(triphenylsilyl)chromate and the like. In such instances, the salt may be contacted with the support using an organic liquid solution followed by vacuum evaporation of the organic solvent at temperatures of from ambient to about 40° C.

In some embodiments, the chromium precursors include chromium sulfate, chromium nitrate, chromium acetate, and chromium acetylacetonate.

The chromium precursor may be immobilized on the support by contacting the support with a solution of the chromium precursor salt.

In each instance, the chromium precursor is introduced as an aqueous or organic solution, or slurry. The materials may be contacted for a period of time of from about 15 to about 150 minutes, with from about 15 to 100 minutes being preferred. In certain instances, the materials are mixed for between 15 and 60 minutes and then allowed to remain in the mixer, without agitation, for a period of up to about 180 minutes. The materials are normally mixed at a temperature of from ambient to about 40° C.

The resulting supported chromium catalyst is then dried. The product of the support that has been treated with chromium precursor is subjected to oxidation to oxidize the chromium atom to a chromium (VI) oxide. The oxidation will typically be conducted at sufficient temperature and time to reduce the total volatiles to between about 0.1 and 8 wt. % where the total volatiles are determined by measuring the weight loss upon destructive calcination of the sample at 1000° C. However, oxidation will typically be conducted by heating the chromium precursor treated support to temperatures of typically from about 600 to about 1800° F. (157 to 815° C.), preferably from about 800 to about 1600° F., and most preferably from about 800 to about 1300° F. for periods of typically from about 1 minute to about 600 minutes (e.g., 50 to 600 minutes), and preferably from about 50 to about 300 minutes. The atmosphere of oxidation should be dried air or other oxygen-laden gas. Oxidation should be conducted in manners that will avoid sintering.

The catalyst system can be used to produce a variety of polyolefins by contacting olefin monomers with the catalyst system comprising the silica support and any of the catalyst precursor compounds described above. The polymerization process may be a bulk polymerization process, a solution phase process, a slurry phase process, or a gas phase process.

In a slurry olefin polymerization process, the silica support generally has a median particle diameter from about 5 μm to about 100 μm, such as from about 20 μm to about 80 μm.

In a gas phase olefin polymerization process, the silica support preferably has a median particle diameter of about 20 μm or greater, such as about 30 μm or greater, such as from about 50 μm to about 100 μm.

In a solution and high pressure olefin polymerization process, the silica support preferably has a median particle diameter from about 4 μm to about 40 μm, such as from about 5 um to about 30 μm, such as from about 6 μm to about 20 μm.

Suitable olefins that can be polymerized in contact with the present catalyst composition include, for examples alpha-olefins having from 2 to about 20, preferably from about 2 to about 12, more preferably from about 2 to about 8 carbon atoms and combinations of two or more of such alpha-olefins. Particularly suitable alpha-olefins include, for example, ethylene, propylene, 1-butene, 1-pentene, 4-methylpentene-1, 1-hexene, 1-heptene, 1-octene, 1-nonene, 1-decene, 1-undecene, 1-dodecene, 1-tridecene, 1-tetradecene, 1-pentadecene, or combinations thereof. Preferably, the alpha-olefins are ethylene, propene, 1-butene, 4-methylpentene-1, 1-hexene, 1-octene, and combinations of ethylene and/or propene with one or more of such other alpha-olefins.

A slurry process typically uses an inert hydrocarbon diluent and temperatures of from about 0° C. up to a temperature just below the temperature at which the resulting polymer becomes substantially soluble in the inert polymerization medium. Preferred temperatures are from about 60° C. to about 105° C. Pressures generally range from 1 to 100 bar. The solution process is carried out at temperatures from the temperature at which the resulting polymer is soluble in an inert solvent or the particular monomer up to about 275° C., preferably at temperatures of from about 130° C. to about 260° C., more preferably from about 150° C. to about 240° C. As inert solvents, typically hydrocarbons, preferably aliphatic hydrocarbons, are used. In solution processes, the pressure is typically from 1 to 100 bar. Typical operating conditions for gas phase polymerizations are from 20° to 100° C., more preferably from 40° to 80° C. In gas phase processes, the pressure is typically from subatmospheric to 100 bar. High pressure processes are carried out at temperatures from about 100° to about 400° C. and at pressures in the range of 500 to 3000 bar.

The present invention, thus generally described, will be understood more readily by reference to the following examples, which are provided by way of illustration and are not intended to be limiting of the present invention.

### EXAMPLES

### Test Methods

The surface area, pore volume, and average pore diameter were measured by nitrogen adsorption. The instrument used for the analysis is an autosorb iQ2 TPX from Quantachrome Instrument. The nitrogen adsorption method is known as BET and is described in S. Brunauer, P. H. Emmett and E.Teller, J. Am. Chem. Soc., 1938, 60, 309.

The samples were activated under vacuum at 400° C. temperature for 30 minutes prior to analysis. Surface areas were calculated from multi-point values of the nitrogen volumetric uptake during the adsorption branch at low [P/Po=˜0.05 to 0.15] partial pressures. The adsorption branch of the isotherm was stopped at a partial pressure of P/Po=0.995 and then the descending branch of the isotherm, was measured. The pore volumes were calculated by applying the Gurvich rule at P/Po=0.995. Pore diameters are reported as calculated BJH desorption average diameter.

The silica gels of this invention are typical mesoporous materials (pore size 2-50 nm, IUPAC definition), and they typically display type IV isotherms (IUPAC classification). Thus, nitrogen porosimetry is an appropriate method for their characterization, and the determination of surface area using the BET method and pore volume using the BJH method from nitrogen adsorption and desorption isotherms are well-established and appropriate methods and are used herein.

The median particle size (D50) and particle size distribution were measured by using a Malvern MS3000 particle size analyzer apparatus from Brightwell Technologies Inc. after sonication for 2 minutes. The measurements were made using a refractive index of 1.49.

Aspect ratio was determined from SEM micrographs using Image-Pro Premier software. For each particle in a sample image, the aspect ratio was calculated by dividing the longest diameter by the shortest diameter. The aspect ratios of the individual particles of each sample were then averaged to determine the average aspect ratio of the particles within the sample. For each sample for which an aspect ratio is provided, about 150 particles were used for the calculation.

Melt flow rate was determined according to ISO 1133-1:2011 (technically equivalent to ASTM D1238-13) at a load of 2.16 kg and temperature of 190° C.

### Example 1

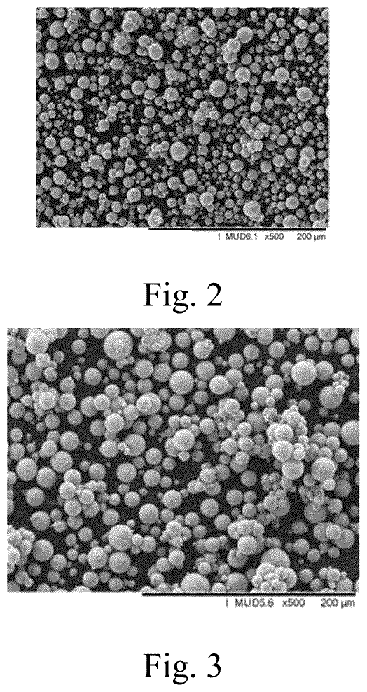

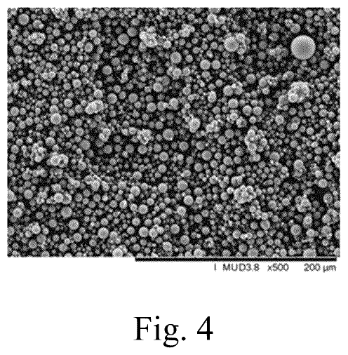

An emulsion process was used to obtain a porous spherical silica material. First, sodium silicate and a mineral acid were reacted to make a sol. The sol was made at a temperature of 15° C. and a pH 1.5 by adding 200 g of sodium silicate (14 wt. %) into 53 g of acid (18.5% HCl) at a flow rate of 10 ml/min and mixing at 960 rpm for 20 min using an overhead mixer. The sol was then pumped to mineral oil (300 g) and surfactant (sorbitan monooleate, 15 g) mixture. The emulsion was made by continuously mixing the mixture at a speed of 960 rpm at a temperature (60° C.) for 10 min using an overhead mixer. The pH was adjusted by adding 2.9 g of ammonium hydroxide into the emulsion to control the gelling process. The emulsion was then mixed at 250 rpm for 5 min. 400 ml water was added to the emulsion. The temperature was then increased to 80° C. The emulsion was mixed at 250 rpm for 1 h for gelation. After the gelation, the mixture was cooled for 30 min and the oil phase was allowed to separate from the water phase. The water phase containing the silica particles was collected and the silica particles were filtered from the water phase. The silica particles were washed using 200 ml of water at pH of 4 at 60° C. while mixing at 250 rpm for 40 min, and then filtered. The washing step was repeated two more times. Then, the particles were washed with isopropanol before drying in a vacuum oven at 60° C. for 1 h. The obtained particles were spherical porous silica and had a D50 particle size of 14 μm and a span of 1.5. The BET surface area of the obtained particles was 456 m²/g, the pore volume was 1.5 ml/g, and the average pore diameter was about 101 Å. An image of the particles is shown in FIG. 4. An image of the particles is shown in FIG. 2.

### Example 2

An emulsion process was used to obtain a porous spherical silica material. First, sodium silicate and a mineral acid were reacted to make a sol. The sol was made at a temperature of 15° C. and a pH 1.5 by adding 253 g of sodium silicate (14 wt. %) into 50.5 g of acid (18.5% HCl) at a flow rate of 10 ml/min and mixing at 960 rpm for 20 min using an overhead mixer. The sol was then pumped into oil (150 g) and surfactant (sorbitan monooleate, 10 g) mixture. The emulsion was made by continuously mixing the mixture at a speed of 960 rpm at a stable temperature (60° C.) for 10 min using an overhead mixer. The pH was adjusted by adding 2.4 g of ammonium hydroxide into the emulsion to control the gelling process. The emulsion was then mixed at 250 rpm for 5 min. 400 ml water was added to the emulsion. The temperature was then increased to 80° C. The emulsion was mixed at 250 rpm for 1 h for gelation. After the gelation, the mixture was cooled for 30 min and the oil phase was allowed to separate from the water phase. The water phase containing the silica particles was collected and the silica particles were filtered from the water phase. The silica particles were washed using 200 ml of water at pH 4 at 60° C. while mixing at 250 rpm for 40 min, and then filtered. The washing step was repeated two more times. Then, the particles were washed with isopropanol before drying in a vacuum oven at 60° C. for 1 h. The obtained particles were spherical porous silica and had a D50 particle size of 17 μm and a span of 1.3. The BET surface area of the obtained particles was 917 m²/g, the pore volume was 1.9 ml/g, and the average pore diameter was about 101 Å. An image of the particles is shown in FIG. 3.

### Example 3

An emulsion process was used to obtain a porous spherical silica material. First, sodium silicate and a mineral acid were reacted to make a sol. The sol was made at a temperature of 15° C. and a pH 1.5 by adding 201 g of sodium silicate (14 wt. %) into 53.5 g of acid (18.5% HCl) at a flow rate of 10 ml/min and mixing at 960 rpm for 20 min using an overhead mixer. The sol was then pumped into oil (91 g) and surfactant (sorbitan monooleate, 7.7 g) mixture. The emulsion was made by continuously mixing the mixture at a speed of 960 rpm at a stable temperature (60° C.) for 10 min using an overhead mixer. The pH was adjusted by adding 1.0 g of ammonium hydroxide into the emulsion to control the gelling process. The emulsion was mixed for 5 more min at 250 rpm. 400 ml water was added to the emulsion. The temperature was then increased to 80° C. The emulsion was mixed at 250 rpm for 1 h for gelation. After the gelation, the mixture was cooled for 30 min and the oil phase was allowed to separate from the water phase. The water phase containing the silica particles was collected and the silica particles were filtered from the water phase. The silica particles were washed using 200 ml of water at pH 4 at 60° C. while mixing at 250 rpm for 40 min, and then filtered. The washing step was repeated two more times. Then, the particles were washed with isopropanol before drying in a vacuum oven at 60° C. for 1 h. The obtained particles were spherical porous silica and had a D50 particle size of 9 μm and a span of 1.1. The BET surface area of the obtained particles was 505 m²/g, the pore volume was 2.5 ml/g, and the average pore diameter was about 189 Å. An image of the particles is shown in FIG. 4.

Table 1 summarizes the properties of the silica particles produced in Examples 1-3.

TABLE 1

| | | | | | Pore | Pore |
|---|---|---|---|---|---|---|
| | | | D10-D90 | BET | Volume | Diameter |
| Example | D50 [μm] | Span | [μm] | [m²/g] | [cc/g] | [Å] |
| 1 | 14.0 | 1.50 | 7.0-28.5 | 456 | 1.53 | 101 |
| 2 | 16.6 | 1.25 | 8.7-29.5 | 917 | 1.94 | 101 |
| 3 | 9.0 | 1.12 | 5.6-15.7 | 505 | 2.53 | 189 |

### Example 4

An emulsion process was used to obtain a mesoporous structured silica material. First, sodium silicate and acid were reacted to make a sol before adding the sol to oil and surfactant to generate an emulsion. The sol was made at a controlled temperature (≤25° C.) and pH (≤1.5) by adding sodium silicate (18%) into the acid (50.0 g, 42% H₂SO₄ Acid) at a flow rate of 10 ml/min and mixing at 500 rpm for 30 min. The sol was then pumped into mixed mineral oil (CX) and surfactant (sorbitan monooleate). The emulsion was made by continuously mixing (using a Rushton impeller) at a speed of 400 rpm at ambient temperature for 25 min after the sol was fully pumped in. The pH was adjusted by adding 6.0 g of ammonium hydroxide over 2 minutes into the emulsion to control the gelling process of the sol. Mixing was continued for another 5 minutes at speed lowered to 250 rpm. With no agitation, the temperature was increased to 80° C. and the emulsion was left to stand for 1h. After the 1 hr reaction, 400 ml of 10% sulfuric acid was added at a speed of 250 rpm for 1 hr, and maintained a temperature of 80° C. Then, the mixture was left for 30 min to cool and let the oil and surfactant separate from the obtained silica particles. The mixture was then filtered to separate the oil and surfactant from the silica particles. The silica particles were then washed using 250 ml of water at 80° C. while mixing at 250 rpm for 30 min and then filtered. The washing step was repeated two more times. Then, the particles were washed with isopropanol once before drying the sample in a vacuum oven at 60° C. for 2 h. The obtained particles had a D50 particle size of 25 μm and a span of 1.71. The average BET surface area of the obtained particles was 741 m²/g, the average pore volume was 2.55 ml/g, and the average pore diameter was about 132 Å.

### Example 5

An emulsion process was used to obtain a mesoporous structured silica material. First, sodium silicate and acid were reacted to make a sol before adding oil and surfactant to the sol to generate an emulsion. The sol was made at a controlled temperature (≤25° C.) and pH (about 1.5) by adding sodium silicate (18 wt. %) into the acid (136.3 g, 15.4 wt. % H₂SO₄) and mixing at 500 rpm for 30 min. A mixture of CX mineral oil (153.7 g) and surfactant (sorbitan monooleate, 8.4 g) was added to the sol. The emulsion was made by continuously mixing at a speed of 400 rpm at ambient temperature for 25 min. The pH was adjusted by adding 6 g of ammonium hydroxide into the emulsion to control the gelling process of the sol. The emulsion was mixed for 5 more min at 250 rpm. The temperature was then increased to 80° C. with no mixing and left for 1h at 80° C. 400 mL of water was then added and the mixture was mixed at 250 rpm and 80° C. for 1 hour. After the reaction, the mixture was left to cool to let the oil phase separate from the water phase. The oil phase was separated off and the particles were filtered from the water phase. The silica particles were then washed using 250 ml of water at 80° C. while mixing at 250 rpm for 30 min. The washing step was repeated two more times. Then, the particles were washed with isopropanol before drying the sample in a vacuum oven at 60° C. for 2 h. The obtained particles had a D50 particle size of 26 μm and a span of 1.63. The average BET surface area of the obtained particles was 506 m²/g, the average pore volume was 1.91 ml/g, and the average pore diameter was about 155 Å.

### Example 6

An emulsion process was used to obtain a mesoporous structured silica material. First, sodium silicate and acid were reacted to make a sol before mixing the sol with surfactant and pumping to oil to generate an emulsion. The sol was made at a controlled temperature (≤25° C.) and pH (1.81) by adding 275.68 g of sodium silicate (14 wt. %) into the acid (50.14 g, 42 wt. % H₂SO₄) at a flow rate of 10 ml/min and mixing at 960 rpm for 20 min. Surfactant (sorbitan monooleate, 9.91 g) was added to the sol and mixed for 5 min at 960 rpm. The sol was then pumped into mineral oil (117.5 g) and continuously mixed at a speed of 960 rpm at a stable temperature (60° C.) for 10 min after the sol was fully pumped in to form an emulsion. 300 mL of DI water was added to the emulsion. The pH was adjusted by adding 1.54 g of 20% ammonia hydroxide with 200 mL of water into the emulsion. The pH reached 2.5. Then 1.06 g of 20% ammonia hydroxide and 10 mL of water were added and the pH reached 4.2. The temperature was increased to 80° C. The emulsion was then mixed at 250 rpm for 1 h. After the reaction, the mixture was left overnight to separate. The mixture was then filtered to separate the oil and surfactant from the silica particles. The silica particles were then washed using acidic water (pH˜4) at 80° C. while mixing at 250 rpm for 90 min. The washing step was repeated two more times. Then, the particles were washed with isopropanol once before drying the sample in a vacuum oven at 60° C. for 1 h. The obtained particles had a BET surface area of 526.2 m²/g, the average pore volume was 1.634 ml/g, and the average pore diameter was 153.5 Å.

### Example 7

An emulsion process was used to obtain a mesoporous structured silica material. First, sodium silicate and acid were reacted to make a sol before pumping the sol to a mixture of surfactant and oil to generate an emulsion. The sol was made by adding 201.35 g of sodium silicate (14 wt. %) into the acid (53.35 g HCl (1:1)) at a flow rate of 10 ml/min and mixing at 960 rpm for 20 min. Surfactant (sorbitan monooleate, 7.61 g) and 90.80 g of mineral oil were combined and mixed for at 960 rpm at 60° C. The sol was then pumped into mineral oil/surfactant mixture at a flow rate of 10 mL/min and continuously mixed at a speed of 960 rpm at a stable temperature (60° C.) for 10 min after the sol was fully pumped in to form an emulsion. 400 mL of DI water was added to the emulsion. The pH was adjusted by adding 1.01 g of 20% ammonia hydroxide into the emulsion. The temperature was increased to 80° C. The emulsion was then mixed at 250 rpm for 1 h. After the reaction, the mixture was left overnight to separate. The mixture was then filtered to separate the oil and surfactant from the silica particles. The silica particles were then washed using acidic water (pH˜4) at 80° C. while mixing at 250 rpm for 90 min. The washing step was repeated two more times. Then, the particles were washed with isopropanol once before drying the sample in a vacuum oven at 60° C. for 1 h. The obtained particles had a BET surface area of 480.04 m²/g, the average pore volume was 2.149 ml/g, and the average pore diameter was 189.8 Å.

### Example 8

Under Argon atmosphere, 3.52 g of the silica particles produced in Example 3 (505 cm2/g SA, 2.53 cc/g PV, 188 Å PD) and 6.48 g of dry toluene were mixed using a magnetic stir bar. MAO (30 wt % in toluene, 4.36 g) was diluted with 7 g of toluene and slowly added to the silica support. The resulting mixture was stirred for 4 hours, then filtered and washed with 10 mL of toluene. After 10 mL of fresh toluene were added, 0.384 g of a solution prepared from 0.771 g of di (1-butyl-3-methylcyclopentadienyl)zirconium dichloride in 2.303 g toluene were added to the stirred slurry of alkylated silica. The mixture was stirred for 4 hours, filtered, and washed with 15 mL of toluene followed by two times with 15 mL of heptane. The solid catalyst was dried under high vacuum for approximately 16 hours. ICP analysis of the catalyst: Al, 11.6 wt %, Zr, 0.42 wt %.

### Example 9

Under Argon atmosphere, 3.54 g of silica produced as in Example 7 and 6.50 g of dry toluene were mixed using a magnetic stir bar. MAO (30 wt % in toluene, 4.36 g) was diluted with 4 g of toluene and slowly added to the silica support. The resulting mixture was stirred for 4 hours, then filtered and washed with 10 mL of toluene. After 10 mL of fresh toluene were added, 0.386 g of a solution prepared from 0.771 g of di (1-butyl-3-methylcyclopentadienyl)zirconium dichloride in 2.303 g toluene were added to the stirred slurry of alkylated silica. The mixture was stirred for 4 hours, filtered, and washed with 15 mL of toluene followed by two times with 15 mL of heptane. The solid catalyst was dried under high vacuum for approximately 16 hours. ICP analysis of the catalyst material: Al, 10.8 wt %, Zr, 0.34 wt %.

### Example 10 (Comparative)

Under Argon atmosphere, 3.45 g of Grace silica XPO-2538 (522 cm²/g SA, 1.86 cc/g PV, 152 Å PD) and 6.48 g of dry toluene were mixed using a magnetic stir bar. MAO (30 wt % in toluene, 4.42 g) was diluted with 5 g of toluene and slowly added to the silica support. The resulting mixture was stirred for 4 hours, then filtered and washed with 10 mL of toluene. After 10 mL of fresh toluene were added, 0.382 g of a solution prepared from 0.771 g of di(1-butyl-3-methylcyclopentadienyl)zirconium dichloride in 2.303 g of toluene were added to the stirred slurry of alkylated silica. The mixture was stirred for 4 hours, filtered, and washed with 15 mL of toluene followed by two times with 15 mL of heptane. The solid catalyst was dried under high vacuum for approximately 16 hours. ICP analysis of the catalyst material: Al, 11.7 wt %; Zr, 0.40 wt %.

### Example 11

Dry sodium chloride (400 g) was charged into a reactor inerted with nitrogen and treated with 8 g of silica containing 10 wt % of solid MAO as scavenger. After heating the reactor to 50° C. while stirring, 60 mg of the catalyst produced in Example 4 was added with 2 mg of the silica-MAO scavenger. The mixing rate was then increased. A mixture of ethylene, hydrogen and 1-hexene was added to achieve a total pressure of 225 psi. The temperature was raised to 85° C. and the polymerization was run for 1 hour. The H2/ethylene molar ratio was maintained at 0.0005 and the 1-Hexane/ethylene molar ratio was maintained at 0.028. The reactor was then depressurized and cooled to ambient temperature before the polymer was collected, washed with water to remove sodium chloride and silica, and dried under vacuum. SEM imaging showed primarily spherical resin particles. The particles are shown in FIG. 8. Activity, 900 gPE/gCat; SBD, 0.45 g/cc; MI(2.16 kg), 0.36 g/10 min, Density, 0.928 g/cc.

### Example 12

The same procedure was used as that for Example 8 but using the silica produced in Example 5. SEM imaging showed primarily spherical resin particles. Activity, 1100 gPE/gCat; SBD, 0.43 g/cc; MI(2.16 kg), 0.86 g/10 min, Density, 0.931 g/cc.

### Example 13

The same procedure was used as that for Example 8 but using the silica formed in Example 6. SEM imaging showed granular morphology reflecting that of the silica support, indicating very little attrition during catalyst preparation and polymerization. Activity, 900 gPE/gCat; SBD, 0.40 g/cc; MI (2.16 kg), 0.69 g/10 min, Density, 0.929 g/cc.

### Example 14A

A portion of Example 4 was dried at 200° C. for 4 hours (giving a surface area of 761 M²/g, 2.61 cc/g pore volume, and 156 angstroms pore diameter) and then 10 grams was weighed into 4 oz plastic container and 0.68 grams of Chromium (III) acetylacetonate 97% (CrAcAc) was then added to make a 1% Cr catalyst sample. The container was shaken for approximately 5 minutes to disperse the CrAcAc throughout the silica.

### Example 14B

Activation of Cr Catalyst: 5 grams of Example 14A were placed into a quartz glass flask that is supported in a furnace. The flask is connected to a cylinder of Ultra Zero grade Air with a flow of 52 l/hr. for a fluidization. The furnace was programmed to reach a temperature of 1550° F. (843° C.) at a ramp rate of 6.7° C. Once the temperature was reached, it was held for 6 hours. Upon completion, the flask was immediately removed from the furnace and allowed to cool to ambient temperature. The activated catalyst was transferred into a separate flask that is then placed into a dessicator. Analysis by ICP of catalyst gave a Cr content of 1.05%.

### Example 14C

Activation of Cr Catalyst: 5 grams of Example 14A were placed into a quartz glass flask that is supported in a furnace. The flask is connected to a cylinder of Ultra Zero grade Air with a flow of 52 l/hr. for a fluidization. The furnace was programmed to reach a temperature of 1300° F. (704.4° C.) at a ramp rate of 6.7° C. Once the temperature was reached, it was held for 5 hours. Upon completion, the flask was immediately removed from the furnace and allowed to cool to ambient temperature. The activated catalyst was transferred into a separate flask that is then placed into a dessicator. Analysis by ICP of catalyst gave a Cr content of 1.01%.

### Example 15A

A portion of Example 5 was dried at 200° C. for 4 hours (giving a surface area of 566 M²/g, 2.12 cc/g pore volume, and 156 angstroms pore diameter) and then ten grams was weighed into 4 oz plastic container and 0.68 grams of Chromium (III) acetylacetonate 97% (CrAcAc) was then added to make a 1% Cr catalyst sample. The container was shaken for approximately 5 minutes to disperse the CrAcAc throughout the silica.

### Example 15B

Activation of Cr Catalyst: 5 grams of Example 15A were placed into a quartz glass flask that is supported in a furnace. The flask is connected to a cylinder of Ultra Zero grade Air with a flow of 52 l/hr. for a fluidization. The furnace was programmed to reach a temperature of 1550° F. (843° C.) at a ramp rate of 6.7° C. Once the temperature was reached, it was held for 6 hours. Upon completion, the flask was immediately removed from the furnace and allowed to cool to ambient temperature. The activated catalyst was transferred into a separate flask that is then placed into a dessicator. Analysis by ICP of catalyst gave a Cr content of 0.98%.

### Example 15C

Activation of Cr Catalyst: 5 grams of Example 15A were placed into a quartz glass flask that is supported in a furnace. The flask is connected to a cylinder of Ultra Zero grade Air with a flow of 52 l/hr. for a fluidization. The furnace was programmed to reach a temperature of 1300° F. (704.4° C.) at a ramp rate of 6.7° C. Once the temperature was reached, it was held for 5 hours. Upon completion, the flask was immediately removed from the furnace and allowed to cool to ambient temperature. The activated catalyst was transferred into a separate flask that is then placed into a dessicator. Analysis by ICP of catalyst gave a Cr content of 0.98%.

### Example 16A

10 g of the silica particles produced in Example 6 were calcined for 4 hours at 150° C. 26.6 g of heptane was added to the calcined silica and mixed to form a slurry at ambient temperature. 1.14 g of TiPT (tetraisopropyl titanate) was then added to the slurry and mixed for 30 min at room temperature. Then, the temperature was raised to 40° C. for 3 hours, and the solvent was removed with a vacuum to form silica with 2 wt. % Ti. Ten grams of the 2 wt. % Ti silica was weighed into 4 oz plastic container and 0.68 grams of Chromium (III) acetylacetonate 97% (CrAcAc) was then added to make a 1% Cr catalyst sample. The container was shaken for approximately 5 minutes to disperse the CrAcAc throughout the silica.

### Example 16B

Activation of Cr Catalyst: 5 grams of Example 16A were placed into a quartz glass flask that is supported in a furnace. The flask is connected to a cylinder of Ultra Zero grade Air with a flow of 52 l/hr. for a fluidization. The furnace was programmed to reach a temperature of 1550° F. (843° C.) at a ramp rate of 6.7° C. Once the temperature was reached, it was held for 6 hours. Upon completion, the flask was immediately removed from the furnace and allowed to cool to ambient temperature. The activated catalyst was transferred into a separate flask that is then placed into a dessicator. Analysis by ICP of catalyst gave a Cr content of 1.10% and a Ti content of 2.15%.

### Example 16C

Activation of Cr Catalyst: 5 grams of Example 16A were placed into a quartz glass flask that is supported in a furnace. The flask is connected to a cylinder of Ultra Zero grade Air with a flow of 52 l/hr. for a fluidization. The furnace was programmed to reach a temperature of 1300° F. (704.4° C.) at a ramp rate of 6.7° C. Once the temperature was reached, it was held for 5 hours. Upon completion, the flask was immediately removed from the furnace and allowed to cool to ambient temperature. The activated catalyst was transferred into a separate flask that is then placed into a dessicator. Analysis by ICP of catalyst gave a Cr content of 1.14% and a Ti content of 2.16%.

### Example 17

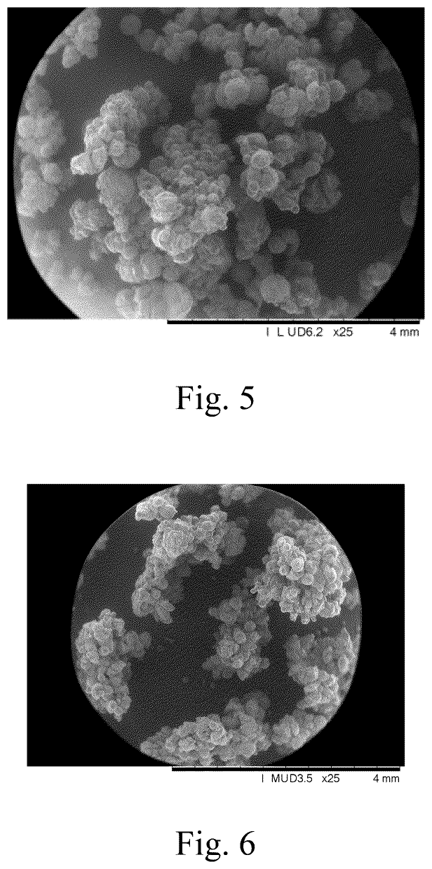

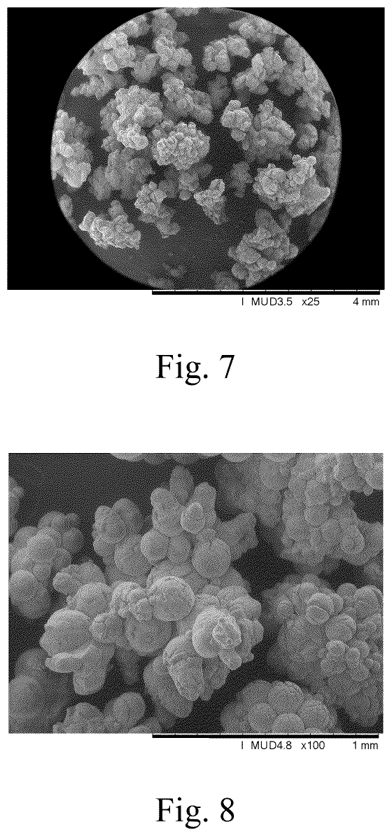

For the polymerization testing of Cr catalysts Activated at 1550° F., 40 mg-60 mg of a Cr catalyst sample was charged into a 103° C. reactor inerted with nitrogen. 1.25 lbs of isobutane was added to the reactor to displace the nitrogen. Stirrer was started and ethylene was added to achieve a total pressure of 550 psi. After 5 minutes, 4.5 ml of 1-hexene was added to the reactor. The polymerization was run to achieve a productivity of 3600-4400 g.PE/g catalyst. The reactor was then depressurized and cooled to ambient temperature before the polymer was collected and dried under vacuum for 7 minutes. Results for examples of 14A, 15A, and 16A are tabulated in Table 2 with Grace commercial references, HA30 (nominally 400 M²/g surface area and 1.4 cc/g pore volume) and HA30W (nominally 500 M²/g surface area and 1.5 cc/g pore volume). SEM images of the polymer fluff are in FIGS. 5-8.

TABLE 2
Cr Catalysts Examples 14A, 15A, and 16A Activated at 1550° F.

| | | | | | Activity | | Avg. Bulk |
|---|---|---|---|---|---|---|---|
| | Activation | Polym. | Hexene, | Productivity | gPE/gCat- | | Density, |
| Example | Temp., ° F. | Temp., ° C. | ml | gPE/gCat | hr | Melt Index | g/ml |
| 14A | 1550 | 103 | 4.5 | 3700 | 12340 | 0.38 | 0.27 |
| 14A | 1550 | 103 | 4.5 | 3690 | 11640 | 0.34 | 0.27 |
| 15A | 1550 | 103 | 4.5 | 4050 | 8100 | 0.28 | 0.30 |
| 15A | 1550 | 103 | 4.5 | 4060 | 8120 | 0.30 | 0.27 |
| 16A | 1550 | 103 | 4.5 | 4050 | 9730 | 0.40 | 0.37 |
| 16A | 1550 | 103 | 4.5 | 3870 | 8940 | 0.42 | 0.37 |
| HA30 | 1550 | 103 | 4.5 | 4000 | 9700 | 0.50 | 0.27 |
| (Comparative) | | | | | | | |
| HA30W | 1550 | 103 | 4.5 | 4000 | 9600 | 0.52 | 0.22 |
| (Comparative) | | | | | | | |

### Example 18

The 1300° F. activated catalyst samples were polymerized at targeted temperatures and hexene amounts to produce a resin that has a density of 0.9518-0.9530 and a Melt Index of 0.27-0.40. For these polymerizations, 40 mg-60 mg of the sample was charged into a 102° C.-105° C. reactor inerted with nitrogen. 1.25 lbs of isobutane was added to the reactor to displace the nitrogen. Stirrer was started and ethylene was added to achieve a total pressure of 550 psi. After 5 minutes, 3.0-6.0 ml of 1-hexene was added to the reactor. The polymerization was run to achieve a productivity of 3600-4400 g. PE/g catalyst. The reactor was then depressurized and cooled to ambient temperature before the polymer was collected and dried under vacuum for 7 minutes. These resins were tested for Environmental Stress Cracking Resistance (ESCR) by ASTM procedure #D1693-07a. Polymerization results are in Table 3.

TABLE 3
Cr Catalysts Example 16A Activated at 1300° F.

| | | | | Activity | | | |
|---|---|---|---|---|---|---|---|
| | Activation | Polym. Temp., | Hexene, | gPE/gCat- | | Density, | |
| Example | Temp., ° F. | ° C. | ml | hr | Melt Index | g/ml | F50 (hrs) |
| 16A | 1300 | 103.2 | 7.4 | 5970 | 0.35 | 0.9509 | 433 |
| 16A | 1300 | 103.0 | 5.8 | 8130 | 0.18 | 0.9525 | 406 |
| HA30 | 1300 | 103.0 | 5.7 | 8500 | 0.34 | 0.9525 | 30 |
| (Comparative) | | | | | | | |
| HA30W | 1300 | 105.5 | 4.2 | 8000 | 0.34 | 0.9525 | 50 |
| (Comparative) | | | | | | | |

### Example 19

13 grams of spherical silica support produced according to the method described in Example 3 (431 m²/g surface area, 2.19 cc/g pore volume, 190 angstroms pore diameter, and 1.15 SPAN) were calcined at 500° C. for 4 hours, generating material with less than 1% total volatiles. The material was transferred to a glove box and 10 grams were charged to a 500 mL Schlenk flask and slurried in 110 mL heptane. 13.3 grams of 20 wt % butylethylmagnesium in hexane were added to the silica slurry drop-wise. The reaction mixture was transferred to a 1 L autoclave reactor and stirred at 25° C. for one hour. Anhydrous hydrogen chloride was bubbled through the reaction mixture for approximately two minutes, until titration with 0.04% bromothymol blue indicated full conversion. 0.99 g TiCl4 was added to the reactor and the reaction mixture was stirred for an hour at 25° C., after which 36 mL of 1.0 M diethylaluminum chloride in hexane was transferred to the procatalyst slowly, generating a deep reddish-brown color. The reaction mixture was stirred for an additional 2 hours at 25° C. before being transferred into a Schlenk flask and dried under high vacuum at room temperature for 2 hours, yielding 15 grams of catalyst.

150 PSI of ethylene was charged to an inerted 2-L autoclave reactor at 50° C. 0.8 mL 20% TEAL in heptane combined with 40 mL 1-hexene was pushed into the reactor with 500 mL isobutane under ethylene pressure, followed by 5 mg of above catalyst in isohexane. The reactor was stirred at 500 rpm and held at 50° C. for 5 minutes, after 215 PSI was dosed in from a 500 mL vessel. The reactor was heated to 85° C. and active ethylene flow was introduced to maintain a total pressure of 370 PSI. The polymerization was run for 1 hour, after which the reactor was depressurized and the resin collected for analysis. SEM imaging showed a mixture of agglomerated and spherical resin particles. Activity, 6102 gPE/gCat; SBD, 0.25 g/cc; MI (2.16 kg) 1.23 g/10 min

### Example 20 (Comparative)

50 grams of granular silica support (XPO-2538) were calcined at 600° C. for 4 hours, generating material with less than 1% total volatiles. The material was transferred to a glove box and 15 grams were charged to a 500 mL Schlenk flask and slurried in 90 mL heptane. 20.7 grams of 20 wt % butylethylmagnesium in hexane were added to the silica slurry drop-wise. The reaction mixture was transferred to a 1 L autoclave reactor and stirred at 25° C. for one hour. Anhydrous hydrogen chloride was bubbled through the reaction mixture for approximately two minutes, until titration with 0.04% bromothymol blue indicated full conversion. 1.5 g TiCl4 was added to the reactor and the reaction mixture was stirred for an hour at 25° C., after which 55 mL of 1.0 M diethylaluminum chloride in hexane was transferred to the procatalyst slowly, generating a deep reddish-brown color. The reaction mixture was stirred for an additional 2 hours at 25° C. before being transferred into a Schlenk flask and dried under high vacuum at room temperature for 2 hours, yielding 22 grams of catalyst.

The same polymerization procedure was used as that for Example 19 SEM showed typical agglomerated morphology. Activity, 6217 gPE/gCat; SBD, 0.28 g/cc; MI(2.16 kg), 1.21 g/10 min

### Example 21

An emulsion process was used to obtain a mesoporous structured silica material. First, sodium silicate and acid were reacted to make a sol before adding oil and surfactant to the sol to generate an emulsion. The sol was made at a controlled temperature (≤25° C.) and pH (about 1.5) by adding sodium silicate (18 wt. %) into the acid (136.3 g, 15.4 wt. % H₂SO₄) and mixing at 500 rpm for 30 min. A mixture of CX mineral oil (153.7 g) and surfactant (sorbitan monooleate, 8.4 g) was added to the sol. The emulsion was made by continuously mixing at a speed of 400 rpm at ambient temperature for 25 min. The pH was adjusted by adding 6 g of ammonium hydroxide into the emulsion to control the gelling process of the sol. The emulsion was mixed for 5 more min at 250rpm. The temperature was then increased to 80° C. with no mixing and left for 1 h at 80° C. 400 mL of 10 wt. % sulfuric acid was then added and the mixture was mixed at 250 rpm and 80° C. for 1 hour. After the reaction, the mixture was left to cool to let the oil phase separate from the water phase. The oil phase was separated off and the particles were filtered from the water phase. The silica particles were then washed using 250 ml of water at 80° C. while mixing at 250 rpm for 30 min. The washing step was repeated two more times. Then, the particles were washed with isopropanol before drying the sample in a vacuum oven at 60° C. for 2 h. The obtained particles had a D50 particle size of 32 μm. The average BET surface area of the obtained particles was 670 m²/g and the average pore volume was 2.75 ml/g.

### Example 22

Under argon atmosphere, 1.91 g of spherical silica prepared according to Example 21, which was calcined at 600° C., was added to a 20 mL vial with small stirbar and dispersed in 5 mL toluene. MAO (4.4 g of 30% solution in toluene) was added dropwise while the silica slurry was gently agitated. The mixture was stirred for 2 h, and then allowed to settle. The supernatant was decanted and 5 mL of toluene was added, after which this wash procedure was repeated. Rac-dimethylsilylenebis(2-methylindenyl)zirconium dichloride (0.031 g) was dissolved in 1 mL of toluene and added dropwise to the silica suspension with gentle stirring, and allowed to stir for 1 hour. The catalyst was isolated by filtration and washed with toluene, then dried under high vacuum. ICP analysis of the catalyst: Al, 16.5 wt %, Zr, 0.17 wt %.

### Example 23 (Comparative)

The catalyst was prepared in the same manner as in Example 22 except that a spray-dried spheroidal silica support was used, having 27 μm d50, 300 m²/g SA, 1.6 cc/g PV.

### Example 24

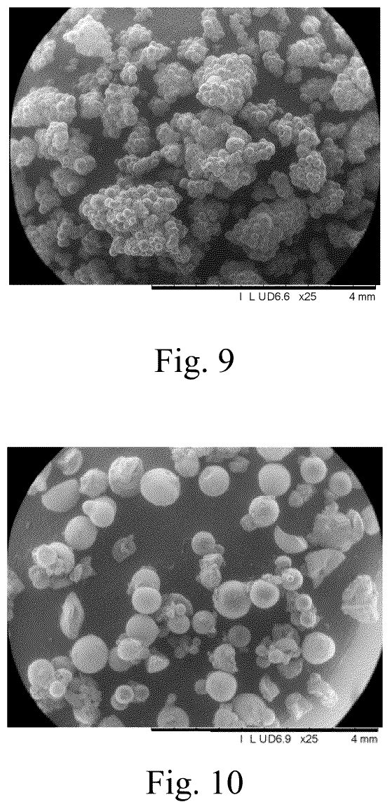

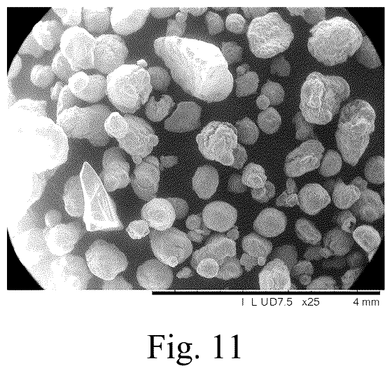

A 2L autoclave reactor was purged with argon at over 100° C., and then flushed with liquid propylene. Under argon atmosphere, to a charge vessel was added 0.5 mL of 25% triethylaluminum in heptane and 3 mL of additional heptane, and the mixture was flushed into the prepared autoclave with 600 mL of propylene. The temperature was raised to 70° C. and agitation started. Approximately 100 mg of catalyst prepared according to Example 22 was weighed into another charge vessel under argon atmosphere, and dispersed in 5 mL of heptane. The catalyst was flushed into the autoclave reactor with 450 mL of propylene and the reaction was allowed to proceed for 1 h after reaching 70° C. The autoclave was then cooled to below 25° C. and vented to collect the polymer, which was allowed to dry under a flow of air. Activity, 3500 gPP/gCat; SBD, 0.42 g/cc. The polypropylene resin had a spheroidal morphology as shown in FIG. 9.

### Example 25 (Comparative)

The same propylene polymerization procedure outlined in Example 24 was followed using the catalyst prepared according to Example 25. Activity, 2300 gPP/gCat; SBD, 0.43 g/cc. The polypropylene resin had a mixture of spheroidal and irregular morphology as shown in FIG. 10.

Para. 1. An olefin polymerization catalyst system comprising a silica support, a catalyst precursor compound, and an activator, the silica support comprising a plurality of silica gel particles, wherein: each particle comprises a rigid network of amorphous silica; the particles are spherical, single gel particles; the particles have an average aspect ratio of about 1.2 or less; the particles have an average pore volume of from about 1.4 ml/g to about 3 ml/g; the particles have an average surface area from about 200 m²/g to about 950 m²/g; and the particles have a median particle size from about 4 μm to about 100 μm.

Para. 2. The olefin polymerization catalyst system of Para. 1, wherein at least 75% of particles have an aspect ratio of about 1.2 or less.

Para. 3. The olefin polymerization catalyst system of Para. 1 or 2, wherein at least 50% of particles have an aspect ratio of about 1.1 or less.

Para. 4. The olefin polymerization catalyst system of any one of Paras. 1-3, wherein the catalyst precursor compound comprises a metallocene component.

Para. 5. The olefin polymerization catalyst system of any one of Paras. 1-4, wherein the activator comprises an organoaluminum compound.

Para. 6. The olefin polymerization catalyst system of any one of Paras. 1-5, wherein the activator comprises an aluminoxane.

Para. 7. The olefin polymerization catalyst system of any one of Paras. 1-6, wherein the activator comprises a borane or borate.

Para. 8. The olefin polymerization catalyst system of any one of Paras. 1-7, wherein the number percentage of silica particles having a particle size of 1 μm or less is about 1% or less.

Para. 9. The olefin polymerization catalyst system of any one of Paras. 1-8, wherein the silica particles have not undergone spray drying agglomeration.

Para. 10. The olefin polymerization catalyst system of any one of Paras. 1-9, wherein the silica particles have an average pore size of from about 30 Angstrom to about 300 Angstrom.

Para. 11. The olefin polymerization catalyst system of any one of Paras. 1-10, wherein the silica particles have an average pore size of from about 100 to about 240 Angstrom.

Para. 12. The olefin polymerization catalyst system of any one of Paras. 1-11, wherein the silica particles have a span of about 1.5 or less.

Para. 13. The olefin polymerization catalyst system of any one of Paras. 1-12, wherein the silica particles have a span of 0.9 or greater.

Para. 14. The olefin polymerization catalyst system of any one of Paras. 1-13, wherein the activator comprises an organoaluminum compound and is loaded on the support such that the catalyst system contains from about 10 wt. % Al or greater.

Para. 15. The olefin polymerization catalyst system of any one of Paras. 1-4, wherein the particles have an average pore volume greater than 2.3 ml/g and an average pore diameter greater than 350 m²/g.

Para. 16. The olefin polymerization catalyst system of any one of Paras. 1-15, wherein the silica particles have a median particle size of from about 5 μm to about 60 μm.

Para. 17. An olefin polymerization catalyst system comprising a silica support and a chromium compound, the silica support comprising a plurality of silica gel particles, wherein: each particle comprises a rigid network of amorphous silica; the particles are spherical, single gel particles; the particles have an average aspect ratio of about 1.2 or less; the particles have an average pore volume of from about 1.4 ml/g to about 3 ml/g; the particles have an average surface area from about 200 m²/g to about 950 m²/g; and the particles have a median particle size from about 4 μm to about 100 μm.

Para. 18. The olefin polymerization catalyst system of Para. 17, wherein at least 75% of particles have an aspect ratio of about 1.2 or less.

Para. 19. The olefin polymerization catalyst system of Para. 17 or 18, wherein at least 50% of particles have an aspect ratio of about 1.1 or less.

Para. 20. The olefin polymerization catalyst system of any one of Paras. 17-19, wherein the chromium compound is a chromium oxide.

Para. 21. The olefin polymerization catalyst system of any one of Paras. 17-20, wherein the chromium compound is a chromium salt.

Para. 22. The olefin polymerization catalyst system of any one of Paras. 17-21, further comprising a titanium compound, aluminum compound, or fluorine compound impregnated on the silica support.

Para. 23. The olefin polymerization catalyst system of any one of Paras. 17-22, wherein the number percentage of silica particles having a particle size of 1 μm or less is about 1% or less.

Para. 24. The olefin polymerization catalyst system of any one of Paras. 17-23, wherein the silica particles have not undergone spray drying agglomeration.

Para. 25. The olefin polymerization catalyst system of any one of Paras. 17-24, wherein the silica particles have an average pore size of from about 30 Angstrom to about 300 Angstrom.

Para. 26. The olefin polymerization catalyst system of any one of Paras. 17-25, wherein the silica particles have an average pore size of from about 100 to about 240 Angstrom.

Para. 27. The olefin polymerization catalyst system of any one of Paras. 17-26, wherein the silica particles have a span of about 1.5 or less.

Para. 28. The olefin polymerization catalyst system of any one of Paras. 17-27, wherein the silica particles have a span of 0.9 or greater.

Para. 29. The olefin polymerization catalyst system of any one of Paras. 17-28, wherein the particles have an average pore volume greater than 2.3 ml/g and an average pore diameter greater than 350 m²/g.

Para. 30. The olefin polymerization catalyst system of any one of Paras. 17-29,wherein the silica particles have a median particle size of from about 5 μm to about 60 μm.

Para. 31. An olefin polymerization catalyst system comprising a silica support, a magnesium halide, a transition metal compound, a cocatalyst, and an electron donor compound, the silica support comprising a plurality of silica gel particles, wherein: each particle comprises a rigid network of amorphous silica; the particles are spherical, single gel particles; the particles have an average aspect ratio of about 1.2 or less; the particles have an average pore volume of from about 1.4 ml/g to about 3 ml/g; the particles have an average surface area from about 200 m²/g to about 950 m²/g; and the particles have a median particle size from about 4 μm to about 100 μm.

Para. 32. The olefin polymerization catalyst system of Para. 31, wherein at least 75% of particles have an aspect ratio of about 1.2 or less.

Para. 33. The olefin polymerization catalyst system of Para. 31 or 32, wherein at least 50% of particles have an aspect ratio of about 1.1 or less.

Para. 34. The olefin polymerization catalyst system of any one of Paras. 31-33, wherein the transition metal compound is a group 4 metal compound.

Para. 35. The olefin polymerization catalyst system of any one of Paras. 31-34, wherein the electron donor compound is an internal electron donor compound.

Para. 36. The olefin polymerization catalyst system of any one of Paras. 31-35, wherein the electron donor compound is an external electron donor compound.

Para. 37. The olefin polymerization catalyst system of any one of Paras. 31-36, wherein the number percentage of silica particles having a particle size of 1 μm or less is about 1% or less.

Para. 38. The olefin polymerization catalyst system of any one of Paras. 31-37, wherein the silica particles have not undergone spray drying agglomeration.

Para. 39. The olefin polymerization catalyst system of any one of Paras. 31-38, wherein the silica particles have an average pore size of from about 30 Angstrom to about 300 Angstrom.

Para. 40. The olefin polymerization catalyst system of any one of Paras. 31-39, wherein the silica particles have an average pore size of from about 100 to about 240 Angstrom.

Para. 41. The olefin polymerization catalyst system of any one of Paras. 31-40, wherein the silica particles have a span of about 1.5 or less.

Para. 42. The olefin polymerization catalyst system of any one of Paras. 31-41, wherein the silica particles have a span of 0.9 or greater.

Para. 43. The olefin polymerization catalyst system of any one of Paras. 31-42, wherein the particles have an average pore volume greater than 2.3 ml/g and an average pore diameter greater than 350 m²/g.

Para. 44. The olefin polymerization catalyst system of any one of Paras. 31-43, wherein the silica particles have a median particle size of from about 5 μm to about 60 μm.

Para. 45. A process for polymerizing an olefin comprising, contacting an olefin monomer with a catalyst system comprising a silica support and a catalyst precursor compound to form polyolefin particles, the silica support comprising a plurality of silica gel particles, wherein: each particle comprises a rigid network of amorphous silica; the particles are spherical, single gel particles; the particles have an average aspect ratio of about 1.2 or lower; the particles have an average pore volume of from about 1.4 ml/g to about 3 ml/g; the particles have an average surface area from about 200 m²/g to about 950 m²/g; and the particles have a median particle size from about 4 μm to about 100 μm.

Para. 46. The process of Para. 45, wherein the resulting polyolefin particles have a particle size distribution such that the number percent of particles having a particle size of 1 μm or less is about 1% or less.

Para. 47. The process of Para. 45 or 46, wherein the olefin is polymerized in a gas phase reactor.

Para. 48. The process of any one of Paras. 45-47, wherein the polyolefin particles have a settled bulk density greater than 0.4 g/cc.

Para. 49. The process of any one of Paras. 45-48, wherein the polyolefin particles have an aspect ratio of about 1.2 or less.

Para. 50. The process of any one of Paras. 45-49, wherein at least 75% of particles have an aspect ratio of about 1.2 or less.

Para. 51. The process of any one of Paras. 45-50, wherein at least 50% of particles have an aspect ratio of about 1.1 or less.

Para. 52. The process of any one of Paras. 45-51, wherein the polyolefin comprises polyethylene.

Para. 53. The process of any one of Paras. 45-52, wherein the polyolefin comprises polypropylene.

Para. 54. The process of any one of Paras. 45-53, wherein the polyolefin comprises a poly α-olefin.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1-60. (canceled)

61. An olefin polymerization catalyst system comprising a silica support, a catalyst precursor compound, and an activator, the silica support comprising a plurality of silica gel particles, wherein:
each particle comprises a rigid network of amorphous silica;
the particles are spherical, single gel particles;
the particles have an average aspect ratio of about 1.2 or less;
the particles have an average pore volume of from about 1.4 ml/g to about 3 ml/g;
the particles have an average surface area from about 200 m²/g to about 950 m²/g; and
the particles have a median particle size from about 4 μm to about 100 μm.

62. The olefin polymerization catalyst system of claim 61, wherein at least 75% of particles have an aspect ratio of about 1.2 or less.

63. The olefin polymerization catalyst system of claim 61, wherein at least 50% of particles have an aspect ratio of about 1.1 or less.

64. The olefin polymerization catalyst system of claim 61, wherein the catalyst precursor compound comprises a metallocene component.

65. The olefin polymerization catalyst system of claim 61, wherein the activator comprises an organoaluminum compound.

66. The olefin polymerization catalyst system of claim 61, wherein the activator comprises an aluminoxane.

67. The olefin polymerization catalyst system of claim 61, wherein the activator comprises a borane or borate.

68. The olefin polymerization catalyst system of claim 61, wherein the number percentage of silica particles having a particle size of 1 μm or less is about 1% or less and/or a median particle size of from about 5 μm to about 60 μm.

69. The olefin polymerization catalyst system of claim 61, wherein the silica particles have not undergone spray drying agglomeration.

70. The olefin polymerization catalyst system of claim 61, wherein the silica particles have an average pore size of from about 30 Angstrom to about 300 Angstrom.

71. The olefin polymerization catalyst system of claim 61, wherein the silica particles have a span of about 1.5 or less and/or a span of 0.9 or greater.

72. The olefin polymerization catalyst system of claim 61, wherein the activator comprises an organoaluminum compound and is loaded on the support such that the catalyst system contains from about 10 wt. % Al or greater.

73. The olefin polymerization catalyst system of claim 61, wherein the particles have an average pore volume greater than 2.3 ml/g and an average pore diameter greater than 350 m²/g.

74. An olefin polymerization catalyst system comprising a silica support and a chromium compound, the silica support comprising a plurality of silica gel particles, wherein:
each particle comprises a rigid network of amorphous silica;
the particles are spherical, single gel particles;
the particles have an average aspect ratio of about 1.2 or less;
the particles have an average pore volume of from about 1.4 ml/g to about 3 ml/g;
the particles have an average surface area from about 200 m²/g to about 950 m²/g; and
the particles have a median particle size from about 4 μm to about 100 μm.

75. An olefin polymerization catalyst system comprising a silica support, a magnesium halide, a transition metal compound, a cocatalyst, and an electron donor compound, the silica support comprising a plurality of silica gel particles, wherein:
each particle comprises a rigid network of amorphous silica;
the particles are spherical, single gel particles;
the particles have an average aspect ratio of about 1.2 or less;
the particles have an average pore volume of from about 1.4 ml/g to about 3 ml/g;
the particles have an average surface area from about 200 m²/g to about 950 m²/g; and
the particles have a median particle size from about 4 μm to about 100 μm.

76. A process for polymerizing an olefin comprising contacting an olefin monomer with the olefin polymerization catalyst system of claim 61 to form polyolefin particles.

77. The process of claim 76, wherein the resulting polyolefin particles have a particle size distribution such that the number percent of particles having a particle size of 1 μm or less is about 1% or less.

78. The process of claim 76, wherein the olefin is polymerized in a gas phase reactor.

79. The process of claim 76, wherein the polyolefin particles have a settled bulk density greater than 0.4 g/cc.

80. The process of claim 76, wherein the polyolefin particles have an aspect ratio of about 1.2 or less.
